(19) United States
(12) Patent Application Publication
(10) Pub. No.: US 2016/0187239 A1
(43) Pub. Date: Jun. 30, 2016

(54) Assay cartridge processing systems and methods and associated assay cartridges

(71) Applicant: MBIO DIAGNOSTICS, INC., Boulder, CO (US)

(72) Inventors: Monique Givens, Westminster, CO (US); Keagan B. Rowley, Boulder, CO (US); Kurt R. Vogel, Boulder, CO (US); Frank William Supon, Louisville, CO (US); Michael J. Lochhead, Boulder, CO (US)

(21) Appl. No.: 14/908,756

(22) PCT Filed: Jul. 29, 2014
(86) PCT No.: PCT/US14/48620

§ 371 Date: Jan. 29, 2016

Related U.S. Application Data
(60) Provisional application No. 61/859,717, filed on Jul. 29, 2013.

(51) Int. Cl. G01N 1/38; B01F 11/00; B01F 13/08; B01L 3/00

(52) U.S. Cl. CPC G01N 1/38; B01L 3/502715; B01L 3/502723; B01F 11/0022; B01F 13/0818; B01L 2300/0838; B01L 2200/06; B01L 2200/14; B01L 2300/0672; G01N 2001/386; B01L 2300/02

(57) ABSTRACT

An assay cartridge processing system includes an agitation source for agitating assay components within an assay cartridge, and a timing module for controlling timing of agitation. An assay cartridge processing method includes applying agitation to an assay cartridge to mix assay components, and electronically controlling timing of agitation. An assay cartridge processing system includes a puncture device for puncturing an assay cartridge to allow fluid flow, and a timing module for controlling timing of puncturing. An assay cartridge processing method includes puncturing a vent of a capillary channel of an assay cartridge to allow fluid flow from an inlet port of the assay cartridge into the capillary channel, and electronically controlling timing of the step of puncturing. An assay cartridge includes a capillary channel, an inlet port, and a vent including a frangible seal for preventing fluid flow from into the capillary channel when the frangible seal is intact.

### CROSS-REFERENCE TO RELATED APPLICATION

This application claims priority to U.S. Provisional Patent Application Ser. No. 61/859,717, filed on Jul. 29, 2013, which is incorporated herein by reference in its entirety.

### U.S. GOVERNMENT RIGHTS

This invention was made with Government support under NIH Grant Nos. AI070052 and AI068543, both awarded by the National Institutes of Health. The Government has certain rights in this invention.

### BACKGROUND

The performance of biological assays includes processes and operations such as mixing and incubation of different assay components. The accuracy of an assay result relies on proper execution of all processes and operations. Many clinical analyzers, used in medical diagnostics, include robotic equipment for carrying out various steps of a biological assay. For example, an operator may load a sample into the clinical analyzer which then mixes a desired sample volume with metered amounts of assay reagents before measuring an assay result. Generally, clinical analyzers with automated assay processing are expensive and such analyzers are therefore not ideal for use in point-of-care settings. For low-resource settings, clinical analyzers may be cost prohibitive. Consequently, low-resource settings rely on manual assay processing and/or very simple assay formats that require minimal processing. However, any manual operation introduces a risk of human error that may adversely affect the accuracy of the assay result, and the simpler assay formats may lack the accuracy, reliability, or sophistication needed to properly diagnose a patient.

### SUMMARY

In an embodiment, an assay cartridge processing system includes (a) a fixture for holding an assay cartridge, (b) at least one agitation source for agitating, when the assay cartridge is held in the fixture, assay components within a fluidic chamber of the assay cartridge, and (c) a timing module including electronic circuitry, communicatively coupled with the agitation source, for controlling timing of operation of the agitation source.

In an embodiment, an assay cartridge processing method includes (a) applying agitation to an assay cartridge, using an electronically controlled agitation source, to mix assay components in the assay cartridge, and (b) electronically controlling timing of the step of applying agitation.

In an embodiment, an assay cartridge processing system includes (a) a fixture for holding an assay cartridge, (b) a puncture device for puncturing a fluidic chamber of the assay cartridge, when the assay cartridge is held in the fixture, to allow fluid flow through the fluidic chamber, and (c) a timing module including electronic circuitry, communicatively coupled with the puncture device, for controlling timing of puncturing by the puncture device.

In an embodiment, an assay cartridge processing method includes (a) puncturing a vent of a capillary channel of an assay cartridge to allow fluid flow from an inlet port of the assay cartridge into the capillary channel, and (b) electronically controlling timing of the step of puncturing.

In an embodiment, an assay cartridge includes (a) a capillary channel, (b) an inlet port including dried assay reagents for reacting with a sample loaded into the assay cartridge via the inlet port, and (c) a vent in fluidic communication with the inlet port through the capillary channel, wherein the vent includes a frangible seal for preventing fluid flow from the inlet port towards the vent when the frangible seal is intact.

### BRIEF DESCRIPTION OF DRAWINGS

FIG. 1 illustrates an assay cartridge processing system for processing an assay cartridge with a fluidic chamber, according to an embodiment.

FIG. 2 illustrates an assay cartridge processing method, according to an embodiment.

FIG. 3 illustrates another assay cartridge processing system, according to an embodiment.

FIGS. 4A and 4B illustrate an assay cartridge processing system for processing one or more assay cartridges, according to an embodiment.

FIG. 5 illustrates an assay cartridge processing system for applying vibration to an assay cartridge, according to an embodiment.

FIGS. 6A, 6B, and 6C show locations for a mechanical oscillator device in an assay cartridge processing system for applying vibration to an assay cartridge, according to embodiments.

FIG. 7 illustrates an assay cartridge processing system for applying vibration to an assay cartridge by inducing pivoting movement of the assay cartridge about a pivot point or pivot axis, according to an embodiment.

FIG. 8 illustrates another assay cartridge processing system for applying vibration to an assay cartridge by inducing pivoting movement of the assay cartridge about a pivot point or pivot axis, according to an embodiment.

FIG. 9 illustrates another assay cartridge processing system for applying vibration to an assay cartridge by inducing pivoting movement of the assay cartridge about a pivot point or pivot axis, wherein vibration is applied to a side of the pivot point/axis that is opposite the side on which assay components to be mixed are located, according to an embodiment.

FIG. 10 illustrates another assay cartridge processing system for applying vibration to an assay cartridge by inducing pivoting movement of the assay cartridge about a pivot point or pivot axis, wherein vibration is applied to a side of the pivot point/axis that is opposite the side on which assay components to be mixed are located, according to an embodiment.

FIG. 11 illustrates an assay cartridge processing system for applying vibration to an assay cartridge through an ambient medium, according to an embodiment.

FIG. 12 illustrates an assay cartridge having an integrated mechanical oscillator in direct contact with a fluidic chamber of the assay cartridge, according to an embodiment, and an assay cartridge processing system for applying vibration to assay components in the assay cartridge using a mechanical oscillator, according to an embodiment.

FIG. 13 illustrates an assay cartridge having an integrated ferromagnetic material, according to an embodiment, and an assay cartridge processing system for applying vibration to the assay cartridge by magnetically inducing motion of the ferromagnetic material, according to an embodiment.

FIG. 14 illustrates an assay cartridge processing system for applying agitation to assay components in an assay cartridge by inducing movement of a ferromagnetic stir element in direct contact with at least some of the assay components, according to an embodiment.

FIG. 15 illustrates an assay cartridge processing system including vibration decoupling features, according to an embodiment.

FIGS. 16A and 16B illustrate an assay cartridge having a flexible portion that interfaces with a desired local region of a fluidic chamber of assay cartridge, according to an embodiment, and an assay cartridge processing system for applying vibration to the flexible portion to agitate assay components in the assay cartridge, according to an embodiment.

FIGS. 17A, 17B, 18A and 18B schematically illustrate an assay cartridge processing method for mixing assay components in an assay cartridge under controlled fluid flow conditions, according to an embodiment.

FIG. 19 illustrates another assay cartridge processing method for mixing assay components in an assay cartridge under controlled fluid flow conditions, according to an embodiment.

FIG. 20 illustrates an assay cartridge processing method that is at least partially performed by an assay cartridge processing system, according to an embodiment.

FIG. 21 shows coefficient of variation achieved in a CD4+ T-cell count experiment using different methods of vibration application.

FIG. 22 shows coefficient of variation achieved in a CD4+ T-cell count experiment using different locations of vibration application.

### DETAILED DESCRIPTION OF THE EMBODIMENTS

Disclosed herein are systems and methods for processing assay cartridges, as well as assay cartridges associated with such systems and methods, to perform biological assays such as immunoassays. The assay cartridge processing systems and methods provide automatic control and performance of assay operations. Commonly, the potential for operator error limits the reliability of an assay system or method. It is therefore beneficial to minimize the number of operations that a user has to perform in order to complete the assay. In a laboratory environment, this problem is frequently overcome by utilizing complex instrumentation including elements such as robotic pipetting and mixing devices, automatic control, and other robotic equipment. However, in other environments such as point-of-care and/or in low-resource settings, these solutions may be cost prohibitive. The present assay cartridge processing systems and methods, and associated assay cartridges, offer solutions compatible with the requirements of low cost and low complexity. An assay cartridge processing system is disclosed, which can manage and carry out assay steps and processes for one or more cartridges. In some embodiments, the assay cartridge processing systems and methods, and the associated assay cartridges, facilitate improved mixing of sample and assay reagents within a fluidic assay cartridge by active mixing. Some embodiments of the assay cartridge processing systems and methods, and the associated assay cartridges, utilize controlling flow of fluids in the assay cartridge to execute assay processing steps.

Generally, biological assays involve reactions between a sample and one or more assay reagents. The assay reagents may be in a dried format for simplified storage and/or improved stability. In certain embodiments of assay cartridges disclosed herein, in certain examples of use of assay cartridge processing systems disclosed herein, and in certain applications of assay cartridge processing methods disclosed herein, the assay cartridge includes a fluidic chamber with dried assay reagents, an inlet port, and an outlet port or vent. In such cases, completion of the assay requires rehydration of the dried reagents by a liquid sample, and mixing of the rehydrated dried reagents and the liquid sample. The liquid sample is, for example, a whole blood sample, optionally including buffers, diluents, and/or other reagents. Rehydration and/or mixing may occur through passive processes such as diffusion. However, active methods may be advantageously applied in some situations including, but not limited to, applications with high requirements to the mixing uniformity and applications with time restrictions conflicting with passive methods.

In a purely passive scheme, rehydration is likely to take place in a non-uniform fashion. For instance, the geometries of the cartridge region wherein rehydration takes place may not facilitate even rehydration of the dried reagent material. Similarly, the geometrical properties of the interface between the liquid sample and the dried reagents may inherently results in position dependent rehydration rates. Additionally, non-idealities such as non-uniform surface energies in the rehydration region may lead to variable rehydration properties. In an embodiment, the dried reagents are deposited within the cartridge as a coating, the thickness of which is subject to some variation, which likely imposes non-uniform rehydration. The mixing that takes place during and following a non-uniform rehydration process necessarily starts in a non-uniform state. Diffusion reduces the non-uniformities. However, depending on the diffusion rates and distances, the required level of mixing uniformity may not be reached in an acceptable amount of time. Even in the case of uniform rehydration, passive mixing may be non-uniform or slow due to, e.g., slow diffusion rates or long diffusion distances.

Certain embodiments of the presently disclosed assay cartridge processing systems and methods utilize active mixing of assay components through agitation of the assay components. These embodiments have utility for improving both the uniformity and rate of rehydration and mixing.

Assay cartridge processing systems and methods, disclosed herein, for applying vibration to an assay cartridge and/or materials contained therein may be advantageously combined with assay cartridge processing systems and methods, also disclosed herein, for holding fluid in a desired location within the assay cartridge. For example, a sample may be held in a region of the fluidic chamber containing dried assay reagents for a period of time sufficient to rehydrate a required amount of dried assay reagents and, optionally, reach the required level of mixing. Agitation may be applied to aid either or both of rehydration and mixing as discussed above. The ability to hold a sample, or other fluid, in a designated rehydration and/or mixing region facilitates improved control of rehydration and mixing times as well as incubation time.

Certain embodiments of assay cartridge processing systems and method disclosed herein provide control of rehydration, mixing, and/or incubation times by use of a frangible surface connected with the fluidic chamber such that before the surface is broken, air trapped in the fluidic channel stops the advancement of fluid. In such embodiments, the fluidic chamber dimensions are such that upon addition of a liquid sample, the liquid “seals” the entrance to the fluidic channel and there is no path for the air in the channel to escape. As a result, a sample loaded into the inlet port is held in the inlet port without substantively entering the fluidic channel. After the surface is broken, the air may escape such that capillary forces can draw the fluid into the fluidic channel towards the broken surface.

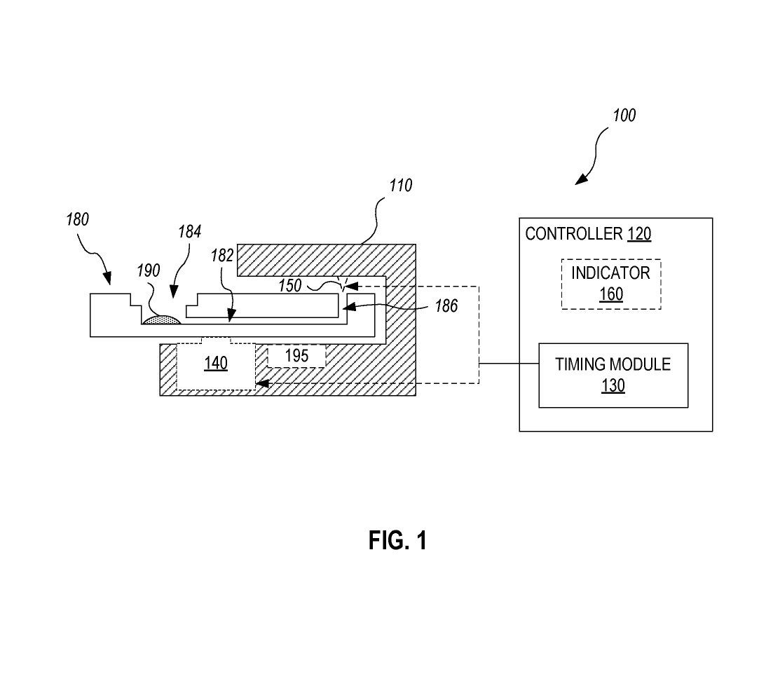

FIG. 1 illustrates, in cross-sectional side view, one exemplary assay cartridge processing system 100 for processing an assay cartridge 180 with a fluidic chamber 182. Assay cartridge processing system 100 includes a fixture 110, capable of holding assay cartridge 180, and at least one of an agitation source 140 and a puncture device 150. Assay cartridge processing system 100 further includes a controller 120. Controller 120 controls at least some functionality of assay cartridge processing system 100, such as operation of agitation source 140 and/or puncture device 150. Controller 120 includes a timing module 130, that is communicatively coupled with agitation source 140 and/or puncture device 150, including electronic circuitry capable of controlling the timing of operation of agitation source 140 and/or puncture device 150. Assay cartridge processing system 100 automatically processes assay cartridge 180. Assay cartridge processing system 100 thereby provides improved reliability and/or accuracy of assay performance, as compared to assay performance achieved manually by a human operator. In some embodiments, puncture device 150 is not controlled by controller 120 but instead actuated by another system or a user.

Assay cartridge 180 may be configured differently from what is shown in FIG. 1, without departing from the scope hereof. For example, fluidic chamber 182 may have dimensions different from those depicted in FIG. 1 and/or be oriented differently from what is shown in FIG. 1. Additionally, a portion of the functionality of agitation source 140 may be incorporated in assay cartridge 180, without departing from the scope hereof.

Agitation source 140 applies agitation to assay components 190 of assay cartridge 180. Assay components 190 include, for example, a sample and assay reagents. Agitation applied by agitation source 140 may facilitate mixing of assay components 190.

The response of assay cartridge 180 and/or assay components 190 to agitation applied by agitation source 140 may depend on the frequency of the agitation applied by agitation source 140. In one example, agitation source 140 generates agitation at a frequency that is resonant or near-resonant with a resonance frequency of assay cartridge 180 such that vibration is efficiently transferred from agitation source 140 to assay cartridge 180. Generally, a system utilizing resonant vibration transfer is more efficient in terms of power consumption than systems using non-resonant vibration transfer. In another example, the agitation frequency generated by agitation source 140 is resonant or near-resonant with a resonance frequency of assay components 190 or a portion thereof. Assay components 190 may include blood cells of greater density than the remainder of assay components 190 and the agitation frequency applied by agitation source 140 may be close to a resonance frequency for oscillation of those blood cells within assay components 190.

In certain examples, the agitation source 140 applies agitation having a frequency that is resonant or near-resonant with a resonance frequency of assay components 190 or portions thereof, while being away from resonance with assay cartridge 180 itself. In such examples, agitation is efficiently transferred to assay components 190 while leaving assay cartridge 180 relatively unaffected. Since assay components 190, or portions thereof, undergoing agitation typically have significantly less mass than assay cartridge 180, this may have the advantage that the desired movement of assay components 190 may be achieved with a lower power consumption than that associated with a system based on resonant agitation transfer to assay cartridge 180. Further, the agitation is less likely to transfer to neighboring objects in contact with assay cartridge 180 or fixture 110, such as other fixtures and assay cartridges, or a structure that holds fixture 110.

Optionally, assay cartridge processing system 100 is configured to apply agitation to assay cartridge 180 at a location close to assay components 190. This may optimize the transfer efficiency of agitation to assay components 190.

Puncture device 150 is configured for use with embodiments of assay cartridge 180, wherein fluidic chamber 182 has an inlet port 184 and an outlet port/vent 186, and wherein fluid flow from inlet port 184 to outlet port/vent 186 must pass through a capillary channel. With such embodiments of assay cartridge 180, puncture device punctures outlet port/vent 186 to allow flow through fluidic chamber 182. When outlet port/vent 186 is closed, fluid flow through the capillary channel is prevented. When puncture device 150 punctures outlet port/vent 186, the capillary channel pulls in fluid from inlet port 184, which is in contact with the capillary channel. Thus, puncture device 150 controls fluid flow through fluidic chamber 182. Some embodiments of assay cartridge processing methods disclosed herein utilize a puncture device, such as puncture device 150, to hold fluid in a certain portion of fluidic chamber 182. Holding fluid in a certain portion of fluidic chamber 182 may allow (a) rehydration of dried assay reagents with a sample, (b) mixing of assay reagents with a sample, and/or (c) incubation of a sample with assay reagents.

In one embodiment, assay cartridge processing system 100 further includes a measurement device 195 that performs measurements of an assay taking place in assay cartridge 180, for example to determine assay results. Although not illustrated in FIG. 1, measurement device 195 may be communicatively coupled with controller 120, such that controller 120 controls operation of measurement device 195, without departing from the scope hereof.

Optionally, controller 120 includes at least one indicator 160 that indicates status of processing of assay cartridge 180 by assay cartridge processing system 100 to an operator. Indicator 160 may indicate status such as “processing cartridge”, “do not remove cartridge”, “processing complete”, “you may remove cartridge”, “agitating”, “initiating flow”, “incubating”, “cartridge properly inserted”, “assay process in progress, do not remove cartridge”, “assay processes complete, okay to remove cartridge”, “incubation time exceeded, assay may not produce valid result”, and “error”. In one embodiment indicator 160 is a light, e.g., an LED, that indicates status by, e.g., being on or off, or flashing at a certain rate. In another embodiment, indicator 160 is a multicolor LED that indicates status by, e.g., being on or off, flashing at a certain rate, being on with a specific color, or flashing with a specific color. In yet another embodiment, indicator 160 is a display or an audible indicator.

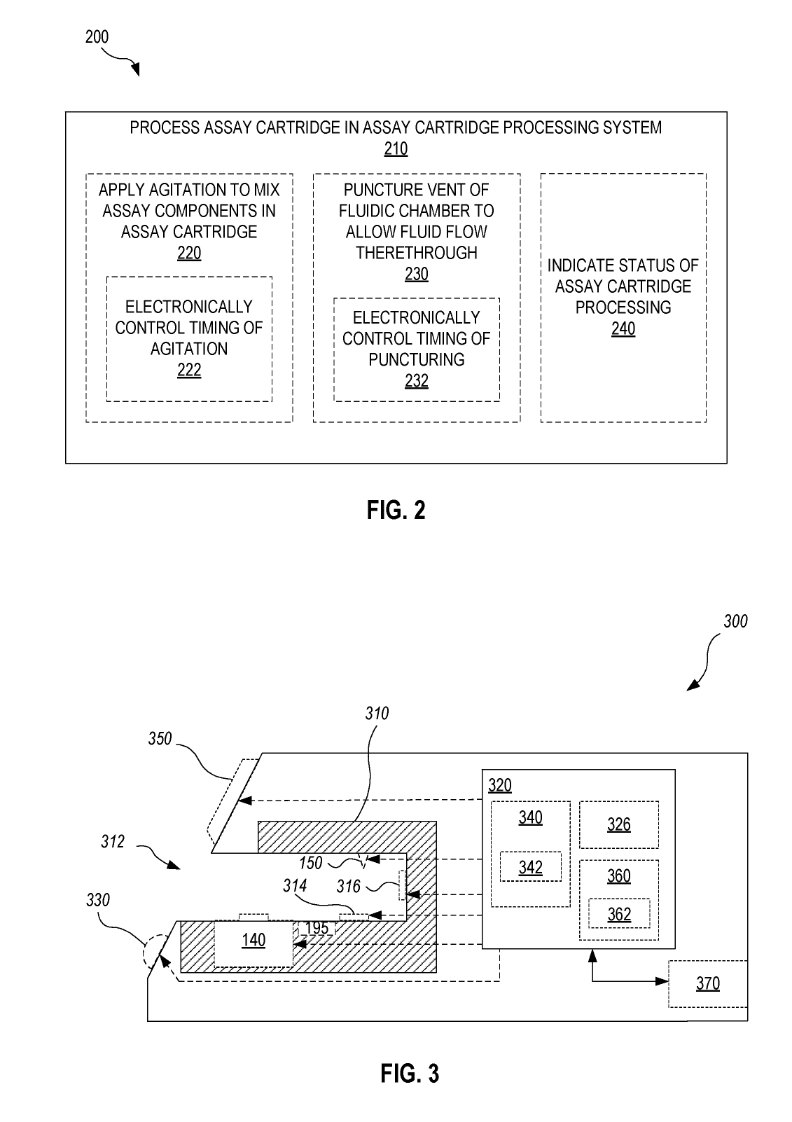

FIG. 2 illustrates one exemplary assay cartridge processing method 200. Assay cartridge processing method may be performed by assay cartridge processing system 100 (FIG. 1). Assay cartridge processing method 200 includes a step 210 of processing an assay cartridge in an assay cartridge processing system. For example, assay cartridge processing system 100 processes assay cartridge 180 (FIG. 1). Step 210 includes at least one of steps 220 and 230. In an embodiment, all processing of the assay cartridge, performed by the assay cartridge processing system, is performed automatically. For example, controller 120 (FIG. 1) controls operation of processing functionality, such as agitation source 140 (FIG. 1) and/or puncture device 150 (FIG. 1), of assay cartridge processing system 100 to process assay cartridge 180.

In step 220, agitation is applied to mix assay components in the assay cartridge. In one embodiment, agitation is applied to the assay cartridge and the resulting motion of the assay cartridge produces motion of the assay components. For example, agitation source 140 applies agitation to assay cartridge 180, which results in agitation of assay components 190 and thus mixing of assay components 190. In another embodiment, agitation is applied directly to the assay components. For example, agitation source 140 applies agitation directly to assay components 190 of assay cartridge 180, to mix assay components 190. In certain embodiments, step 220 includes a step 222 of electronically controlling the timing of the agitation. Step 222 may control timing in accordance with an assay protocol. For example, timing module 130 (FIG. 1) controls the timing of operation of agitation source 140.

In step 230, a vent of a fluidic chamber of the assay cartridge is punctured to allow flow through at least a portion of the fluidic chamber. When step 230 is applied to an assay cartridge configured with a capillary channel, step 230 may initiate fluid flow into the capillary channel, as discussed in connection with FIG. 1. For example, puncture device 150 (FIG. 1) punctures outlet port/vent 186 (FIG. 1), which is sealed prior to performing step 230, to initiate fluid flow from inlet port 184 (FIG. 1) into a capillary channel that provides a connection between inlet port 184 (FIG. 1) and outlet port/vent 186. In certain embodiments, step 230 includes a step 232 of electronically controlling the timing of the agitation. Step 232 may control timing in accordance with an assay protocol. For example, timing module 130 (FIG. 1) controls the timing of operation of puncture device 150.

Optionally, step 210 includes a step 240 of indicating assay cartridge processing status to an operator. Step 240 may indicate whether or not assay cartridge processing is in progress, whether or not assay cartridge processing is complete, which type of assay cartridge processing is currently taking place, time left before completion, and other types of status indications. In an example of step 240, indicator 160 (FIG. 1) indicates status of processing of assay cartridge 180 to a user. Assay cartridge processing method 200 may perform step 240 in parallel with other steps.

FIG. 3 illustrates one exemplary assay cartridge processing system 300 which is an embodiment of assay cartridge processing system 100 (FIG. 1). Assay cartridge processing system 300 includes a fixture 310, which is one embodiment of fixture 110 (FIG. 1) that is capable of holding an assay cartridge inserted into opening 312 of assay cartridge processing system 300. Assay cartridge processing system 300 further includes a controller 320, which is an embodiment of controller 120 (FIG. 1).

Controller 320 includes one or more microprocessors 360 with memory 362. Memory 362 may include non-transitory machine-readable instructions, encoded in non-volatile memory, for processing assay cartridges. For example, memory 362 may include machine-readable instructions for performing predefined assay protocols. Without departing from the scope hereof, microprocessor 360 may be replaced by another processing device such as a field programmable gate array (FPGA).

In one embodiment, controller 320 includes a code reader device 326 that reads barcodes, or other type(s) of information indicia/signals, located on an assay cartridge, e.g., assay cartridge 180 of FIG. 1. Such information may include, or be associated with, assay protocol details, for instance incubation times, order of operations, duration of operations and/or processes, and nature of operations. Electronic circuitry of controller 320 may interpret this information and optionally include memory, for example memory 362, for storage of related information. In another embodiment, controller 320 is in communication, through an optional interface 370, with another device having such capability. For example, controller 320 communicates, through optional interface 370, with a reader instrument used to read out the results of an assay after processing of the assay cartridge in assay cartridge processing system 300. In yet another embodiment, code reader device 326 is an external device in communication with controller 320 through optional interface 370. Optionally, code reader device 326 is in communication with optional interface 370 through a different device such as a reader device for reading of the results of an assay cartridge. Optional interface 370 may also provide an interface for communication with other systems or devices external to assay cartridge processing system 300. Optional interface 370 may be an electronic port. Optional interface 370 may be a wired or wireless interface.

In an embodiment, assay cartridge processing system 300 receives electrical power through interface 370, for instance through a simple power inlet or through, e.g., a USB port connected to another, powered device. In another embodiment, assay cartridge processing system 300 includes a battery that may serve as the only power source for cartridge processing system 300 or as a back-up power source.

Controller 320 may include firmware or software, as non-transitory machine-readable instructions, executed by a processor to perform the processes disclosed herein.

Controller 320 includes a timing module 340, which is an embodiment of timing module 130 (FIG. 1). Optionally, timing module 340 includes one or more electronic timers 342 for timing of certain processes or operations related to the performance of an assay within an assay cartridge. Timing module 340 may be connected to an optional display 350 that communicates timing information to an operator.

In an embodiment, optional display 350 indicates timing information such as a countdown until completion of a process, e.g., an incubation, or a count-up indicating time passed since completion of a process, e.g., an incubation. Optional display 350 may also be used to indicate other types of information. In one embodiment, display 350 is a numeric display that shows one or more of time, error codes, the number of steps completed, and the number of steps remaining. Optional display 350 may also flash numbers to indicate a particularly important message to an operator. In another embodiment, display 350 displays non-numeric information such as text, symbols, icons, or pictures to communicate more complex information to the operator.

Assay cartridge processing system 300 further includes at least one of agitation source 140 (FIG. 1) and puncture device 150 (FIG. 1). When included in assay cartridge processing system 300, agitation source 140 and puncture device 150 are communicatively coupled with controller 320 and timing module 340. Controller 320 controls timing, and optionally other aspects, of operation of agitation source 140 and/or puncture device 150.

Optionally, the insertion of an assay cartridge into opening 312 is detected by a cartridge sensor 316 included in fixture 310. Cartridge sensor may be based upon one or more mechanisms known in the art, such as a spring loaded interlock switch or a photo sensor. In one embodiment, cartridge sensor 316 is configured to initialize a timer 342, upon sensing of a cartridge fully inserted in fixture 310, whereby cartridge insertion provides a time reference for subsequent processes and/or operations. For example, detection of cartridge insertion by cartridge sensor 316 may initiate, optionally after a specified delay, an incubation time, a mixing step induced by agitation source 140, and/or puncturing of fluidic chamber by puncture device 150.

In an embodiment, fixture 310 includes a latching mechanism 314 for preventing premature removal of an assay cartridge. Latching mechanism 314 may be controlled by timing module 340, which unlocks latching mechanism 314 upon completion of all assay processes.

In an embodiment, assay cartridge processing system 300 includes measurement device 195 (FIG. 1).

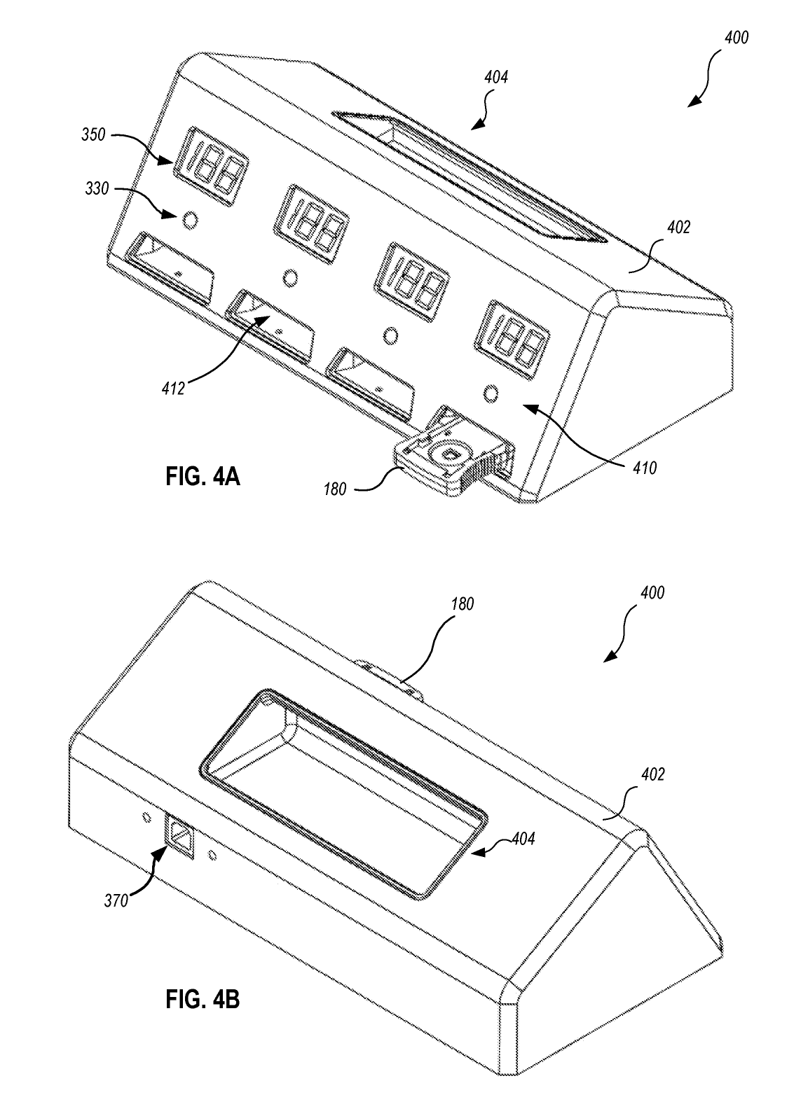

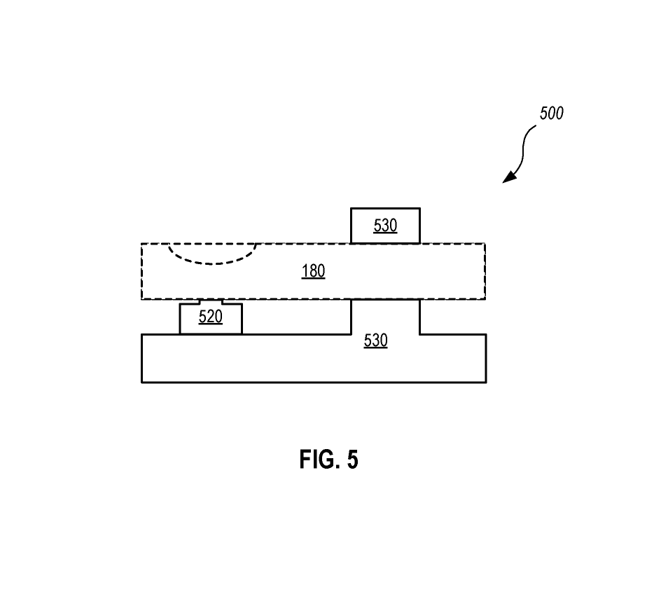

FIGS. 4A and 4B illustrate, in perspective views, one exemplary assay cartridge processing system 400 for processing one or more assay cartridges 180 (FIG. 1). Assay cartridge processing system 400 is configured as a rack. FIGS. 4A and 4B show assay cartridge processing system 400 from the side of cartridge insertion and the side opposite thereto, respectively. Assay cartridge processing system 400 is illustrated with capacity for holding four cartridges. However, assay cartridge processing system 400 may hold any number of cartridges without departing from the scope hereof. Assay cartridge processing system 400 includes an enclosure 402, an optional carrying handle 404 that may have an ergonomic shape, interface 370 (FIG. 3), and one or more assay cartridge processing units 410 (four shown in FIGS. 1 and 2).

Each assay cartridge processing unit 410 is an embodiment of assay cartridge processing system 100 (FIG. 1) or assay cartridge processing system 300 (FIG. 3). Each assay cartridge processing unit 410 in assay cartridge processing system 400 includes an opening 412 for accepting fluidic assay cartridge 180. Each assay cartridge processing unit 410 may include its own dedicated electronic circuitry, optionally including at least one indicator 330 and timing system with display 350, for controlling assay operations and processes in or on assay cartridge 180. In embodiments of assay cartridge processing system 400 having more than one assay cartridge processing unit 410, different assay cartridge processing units 410 may share at least some elements of control circuitry. For example, two or more assay cartridge processing systems 300 implemented as assay cartridge processing units 410 may share a single microprocessor 360 (FIG. 3) and a single interface 370. Although FIG. 4B shows only one interface 370, assay cartridge processing system 400 may include several instances of interface 370 without departing from the scope hereof.

In one embodiment, all assay cartridge processing units 410 are identically configured. In another embodiment, differences exist between the configurations of at least some of assay cartridge processing units 410 such that different cartridge processing units 410 may have different capabilities, for instance for processing of different types of assay cartridges 180. Assay cartridge processing system 400 may process multiple assay cartridges 180 synchronously, simultaneously, sequentially, or a combination thereof. For example, assay cartridge processing system 400 may perform agitation steps on individual cartridges at different times.

FIG. 5 illustrates one exemplary assay cartridge processing system 500 for applying vibration to an assay cartridge such as assay cartridge 180. Vibration applied to assay cartridge 180 by assay cartridge processing system 500 may facilitate uniform mixing (or at least improved mixing as compared to passive mixing) of a sample with assay reagents deposited within assay cartridge 180. Assay cartridge processing system 500 may be implemented in assay cartridge processing system 100 (FIG. 1), assay cartridge processing system 300 (FIG. 3), and/or assay cartridge processing system 400 (FIG. 4). Assay cartridge processing system 500 includes a fixture 530, configured to hold assay cartridge 180, and a mechanical oscillator device 520 that applies vibration to assay cartridge 180 while held in fixture 530.

Mechanical oscillator device 520 is an embodiment of agitation source 140 (FIG. 1). Fixture 530 is an embodiment of fixture 110 (FIG. 1).

Fixture 530 is configured to hold assay cartridge 180 in a way that allows for some movement of assay cartridge 180. For example, assay cartridge 180 may be allowed to pivot about a pivot point or axis defined by one or more points of contact between assay cartridge 180 and fixture 530. Mechanical oscillator device 520 may apply vibration in any direction including, but not limited to, a direction substantially perpendicular to the primary fluid flow through the fluidic chamber (i.e., a direction substantially vertical in FIG. 5), a direction substantially parallel to the primary fluid flow through the fluidic chamber (i.e., a direction substantially horizontal in FIG. 5), or a combination thereof. In an embodiment, mechanical oscillator device 520 applies vibration to assay cartridge 180 using the same vibration configuration for the duration of the vibration process. In another embodiment, mechanical oscillator device 520 applies vibration to assay cartridge 180 following a sequence of different vibration configurations such that, for example, vibration directionality, frequency, and/or amplitude vary during the duration of the vibration process.

Mechanical oscillator device 520 may include a variety of mechanical oscillators for producing vibration. Examples thereof include, but are not limited to, an offset weight motor, an induction coil vibrator, a piezoelectric material, or a combination thereof. Other vibration mechanisms or sources may be used without departing from the scope hereof. Mechanical oscillator device 520 may include one, two, or more individual mechanical oscillators, and the one, two, or more mechanical oscillators may be placed differently from that illustrated in FIG. 5, without departing from the scope hereof. Also without departing from the scope hereof, fixture 530 may contact assay cartridge 180 in fewer or more different locations, and in other locations than illustrated in FIG. 5.

In one embodiment, mechanical oscillator device 520 is in contact with assay cartridge 180 throughout the duration of vibration of assay cartridge 180. In another embodiment, mechanical oscillator device 520 is in periodic or intermittent contact with assay cartridge 180 during vibration thereof. Vibration, as referred to herein, need not be a regular oscillation. Vibration may be, for example, irregular, a single pulse, or a series of pulses. Vibration may further be of, e.g., sinusoidal, square-wave, or delta function nature.

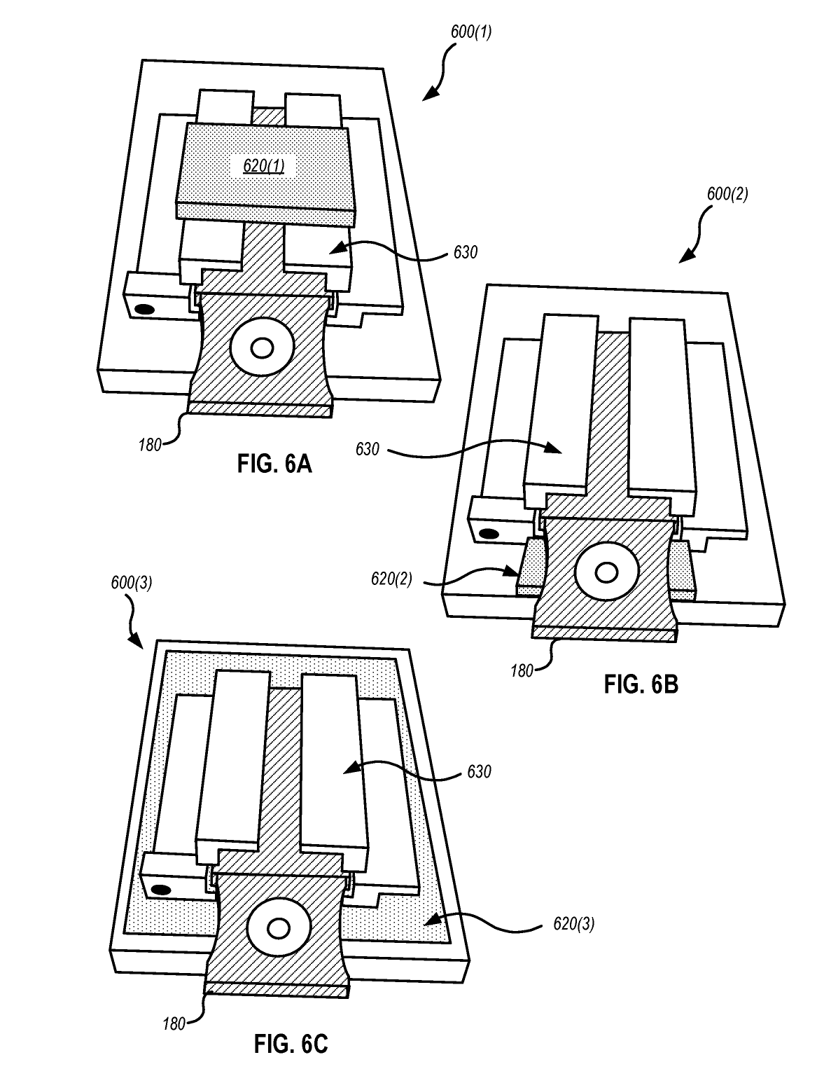

FIGS. 6A-C show exemplary locations for a mechanical oscillator device in exemplary assay cartridge processing systems 600(1)-600(3) for applying vibration to an assay cartridge such as assay cartridge 180. Assay cartridge processing systems 600(1)-(3) are embodiments of assay cartridge processing system 500 of FIG. 5 and may be implemented in assay cartridge processing systems 100, 300, and/or 400 of FIGS. 1, 3, and 4 respectively. Assay cartridge processing systems 600(1)-600(3) include a fixture 630 for holding assay cartridge 180 and a mechanical oscillator device 620. Fixture 630 and mechanical oscillator device 620 are embodiments of fixture 530 (FIG. 5) and mechanical oscillator device 520 (FIG. 5), respectively.

FIG. 6A illustrates assay cartridge processing system 600(1), in one embodiment, wherein mechanical oscillator device 620(1) applies vibration to the top of fixture 630. The vibration propagates from the top of fixture 630 to assay cartridge 180 through one or more points/areas of contact between fixture 630 and assay cartridge 180.

FIG. 6B illustrates another assay cartridge processing system 600(2), wherein mechanical oscillator device 620(2) applies vibration directly to assay cartridge 510. Mechanical oscillator device 620(2) may apply vibration, to assay cartridge 180, through an oscillatory expansion of its size in the dimension that spans the gap between fixture 630 and assay cartridge 180. While this form of vibration may be achieved with a range of devices, piezoelectric materials may be particularly well suited for implementation in this embodiment. Piezoelectric materials contract and expand according to an applied voltage and therefore inherently provide the desired form of dimensional variation. The size change magnitude is a function of the variation in the applied voltage.

In one embodiment, mechanical oscillator device 620(2) includes a single piezoelectric material. In another embodiment, mechanical oscillator device 620(2) includes a stack of piezoelectric materials. The multiple layers of a piezoelectric stack are electrically connected in parallel and cooperate to produce a greater size change magnitude than that achievable with a single layer, under identical voltage conditions. Alternatively, such a stack of piezoelectric materials may be used to achieve the same size change magnitude as that achieved with a single layer, with a lower applied voltage.

In an embodiment of assay cartridge processing system 600(2), mechanical oscillator device 620(2), e.g., a piezoelectric vibrator, is incorporated in assay cartridge 180 rather than fixed to fixture 630. Power may be applied to mechanical oscillator device 620(2) from fixture 630 through contact points (not shown in FIG. 6B) between fixture 630 and assay cartridge 180. In the case of a disposable, as opposed to reusable, assay cartridge, the driving electronics for mechanical oscillator device 620(2) may be advantageously located externally to assay cartridge 180 to reduce the assay cartridge cost, size, and waste associated disposal of assay cartridge 180.

FIG. 6C illustrates assay cartridge processing system 600(3), wherein mechanical oscillator device 620(3) is integrated in fixture 630. A portion of fixture 630, including the portion that holds assay cartridge 180, is subject to vibration applied by mechanical oscillator device 620(3).

In some embodiments of assay cartridge processing systems 600(1), 600(2), and 600(3), assay cartridge 180 is held fixed in relation to fixture 630. In other embodiments of assay cartridge processing systems 600(1), 600(2), and 600(3), fixture 630 is configured to allow for some movement of assay cartridge 180 relative to fixture 630 while remaining in contact with fixture 630 through one or more contact points or contact areas. In further embodiments of cartridge processing systems 600(1), 600(2), and 600(3), assay cartridge 180 is held loosely by fixture 630, such that fixture 630 limits the range of motion of assay cartridge 180 during vibration without necessarily maintaining uninterrupted physical contact between the two.

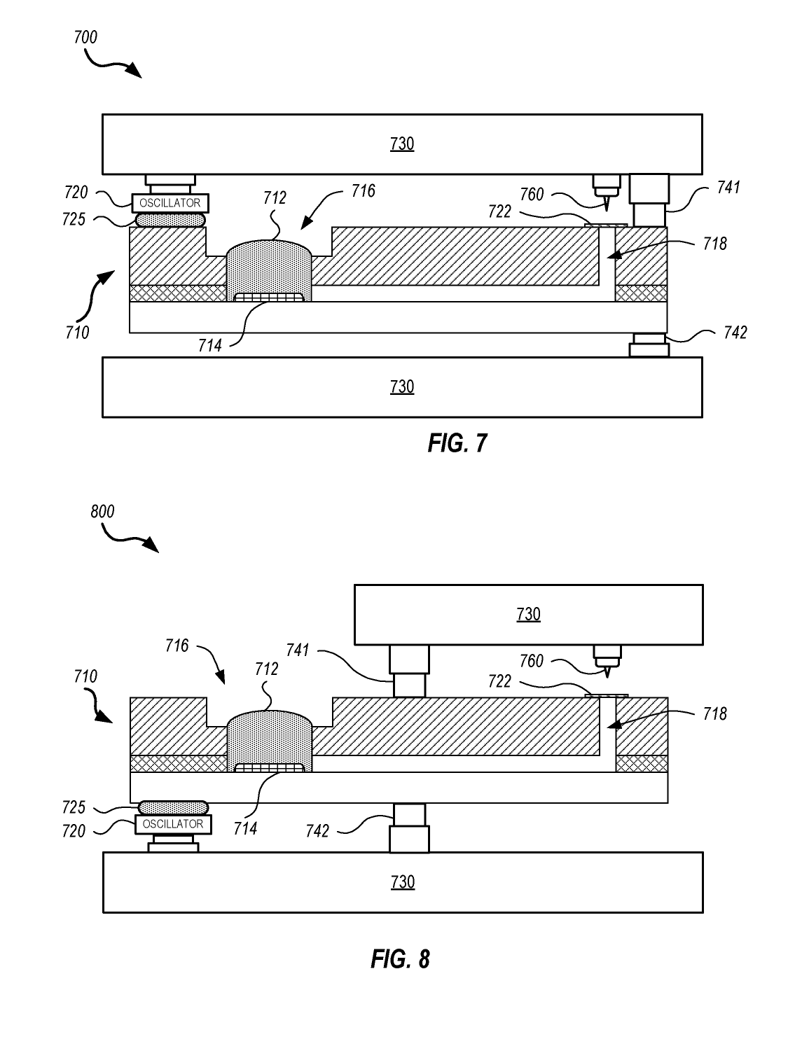

FIG. 7 illustrates one exemplary assay cartridge processing system 700 for applying vibration to an assay cartridge 710 by inducing pivoting movement of assay cartridge 710 about a pivot point or pivot axis. Assay cartridge processing system 700 is an embodiment of assay cartridge processing system 500 of FIG. 5 and may be implemented in assay cartridge processing systems 100, 300 and/or 400 of FIGS. 1, 3, and 4, respectively. Assay cartridge 710 is an embodiment of assay cartridge 180 (FIG. 1). Assay cartridge processing system 700 includes a fixture 730 configured to hold assay cartridge 710 with contact elements 741 and 742. Fixture 730 is an embodiment of fixture 530 (FIG. 5).

Assay cartridge processing system 700 further includes a mechanical oscillator 720 that induces pivoting motion of assay cartridge 710 about a pivot point or pivot axis defined by contact elements 741 and 742. In an embodiment, illustrated in FIG. 7, mechanical oscillator 720 is mounted to fixture 730 above assay cartridge 710 and applies vibration to assay cartridge 710 from above. Mechanical oscillator 720 may be mounted to fixture 730 below assay cartridge 710 and apply vibration to assay cartridge 710 from below, similar to the illustration in FIG. 8, without departing from the scope hereof.

Contact elements 741 and 742 may be rigid or flexible, or a combination thereof, to define the desired motion of assay cartridge 710. In an embodiment, each of contact elements 741 and 742 contacts assay cartridge 710 only at a point or along a line, so as to promote unrestricted pivoting motion of assay cartridge 710.

In one embodiment, assay cartridge processing system 700 includes a flexible material 725, such as rubber or silicone, at the interface between mechanical oscillator 720 and assay cartridge 710. Flexible material 725 may serve to maintain consistent contact between mechanical oscillator 720 and assay cartridge 710 during vibration. Without departing from the scope hereof, flexible material 725 may be incorporated in assay cartridge 710 instead of is assay cartridge processing system 700. Mechanical oscillator 720, optionally together with flexible material 725, is an embodiment of mechanical oscillator device 520 (FIG. 5).

In an embodiment, not illustrated in FIG. 7, a flexible material is inserted between mechanical oscillator 720 and fixture 730 to dampen transfer of vibration from mechanical oscillator 720 to fixture 730.

Optionally, assay cartridge processing system 700 further includes a puncture device 760 which is an embodiment of puncture device 150 (FIG. 1).

In an exemplary use scenario, assay components, such as a sample 712 and assay reagents 714 for reacting with sample 712, are located in an inlet port 716 of assay cartridge 710. Assay reagents 714 may be dried reagents, in which case vibration applied to assay cartridge 710 by mechanical oscillator 720 may further serve to improve the properties of rehydration of assay reagents 714 by sample 712. Contact elements 741 and 742 are advantageously placed away from the region of assay cartridge 710 that contains the assay components, e.g., sample 712 and assay reagents 714, which are to be mixed. This configuration results in greater vibration amplitude of this region of assay cartridge 710.

The distance between the pivot point/axis, defined by contact elements 741 and 742, and the location where mechanical oscillator device 720 applies vibration to assay cartridge 710 may be adjusted to change the properties of vibration transferred to assay cartridge 710 and/or the assay components to be mixed, e.g., sample 712 and assay reagents 714. For example, the resonance frequency for vibration of assay cartridge 710 changes with this distance, which may be optimized to achieve resonant or near-resonant vibration of assay cartridge 710 or one or more of the assay components. Additionally, mechanical oscillator 720 may interface with assay cartridge 710 on a side of the pivot point/axis, defined by contact elements 741 and 742, that is opposite the side on which the assay components to be mixed are located.

Assay cartridge 710 may be used to perform other assays based upon other or more assay components than sample 712 and assay reagents 714, without departing from the scope hereof. Without departing from the scope hereof, assay components, such as sample 712 and assay reagents 714, may be located in a portion of assay cartridge 710 different from what is shown in FIG. 7.

FIG. 8 illustrates one exemplary assay cartridge processing system 800 which is similar to assay cartridge processing system 700 of FIG. 7 except for modified location of contact elements 741 and 742 and mechanical oscillator 720. In assay cartridge processing system 800, mechanical oscillator 720 applies vibration to assay cartridge 710 from below, and contact elements 741 and 742 are moved to a more central location. Hence, as compared to assay cartridge processing system 700, the distance between the pivot axis/point, defined by contact elements 741 and 742, and the interface location between mechanical oscillator 720 and assay cartridge 710 is reduced. This leads to different vibration properties including a different resonance frequency for vibration of assay cartridge 710. Without departing from the scope hereof, mechanical oscillator 720 may be located above assay cartridge 710, similar to the configuration illustrated in FIG. 7.

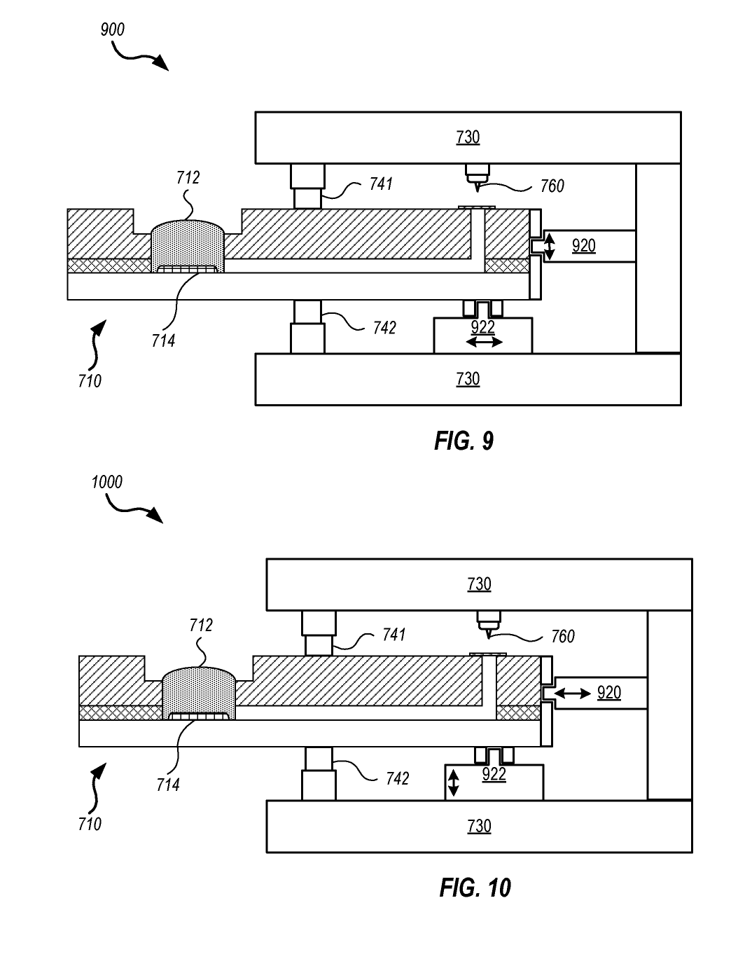

FIG. 9 illustrates one exemplary assay cartridge processing system 900 which is similar to assay cartridge processing system 800 (FIG. 8). Assay cartridge processing system 900 is configured to apply vibration to assay cartridge 710 on a side of the pivot point/axis that is opposite the side on which assay components, e.g., sample 712 and assay reagents 714, to be mixed are located. Assay cartridge processing system 900 is an embodiment of assay cartridge processing system 500 (FIG. 5) and may be implemented in assay cartridge processing systems 100 (FIG. 1), 300 (FIG. 3), and or 400 (FIG. 4). Instead of mechanical oscillator 720, assay cartridge processing system 900 includes two mechanical oscillators 920 and 922 that induce motion of assay cartridge 710 along two substantially perpendicular dimensions. Assay cartridge processing system 900 may utilize mechanical oscillators 920 and 922 to perform a vibration procedure that includes sequential, alternating, and/or concurrent application of vibration by mechanical oscillators 920 and 922.

Mechanical oscillator 920 applies vibration to assay cartridge 710 at its end, and induces pivoting motion about the pivot point/axis defined by contact elements 741 and 742. Mechanical oscillator 922 applies vibration to assay cartridge 710 from underneath, and induces motion perpendicular to the pivoting motion. In this case, contact elements 741 and 742 allow for assay cartridge 710 to slide on contact elements 741 and 742. In an embodiment, contact elements 741 and 742 include ball bearings or rollers at the interfaces with assay cartridge 710.

Although not illustrated in FIG. 9, flexible material one or both of interfaces between mechanical oscillators 920 and 922 may be equipped with flexible material 725 without departing from the scope hereof. Additionally, assay cartridge processing system 900 may be extended to other numbers of mechanical oscillators, such as one, three, four, or more mechanical oscillators.

In certain embodiments, the ratio of (a) the distance between the point of pivoting vibration application (by mechanical oscillators 920 and/or 922) and the pivot point/axis (defined by contact elements 741 and 742) to (b) the distance from the assay components to mixed (sample 712 and assay reagents 714) to the pivot point/axis is configured to be different from one. This allows for producing a vibration amplitude of the assay components, to be mixed, which is greater or smaller than the vibration amplitude applied by the mechanical oscillator.

FIG. 10 illustrates one exemplary assay cartridge processing system 1000 which is similar to assay cartridge processing system 900 (FIG. 9), except that the directions of motion induced by mechanical oscillators 920 and 922 are interchanged (as indicated by the arrows associated with each mechanical oscillator 920, 922 in each of FIGS. 9 and 10). Mechanical oscillator 920 applies vibration to the end of assay cartridge 710 and induces motion that causes assay cartridge 710 to slide on contact elements 741 and 742. Mechanical oscillator 922 applies vibration to assay cartridge 710 from underneath assay cartridge 710 to induce pivoting motion of assay cartridge 710 about the pivot point/axis defined by contact elements 741 and 742.

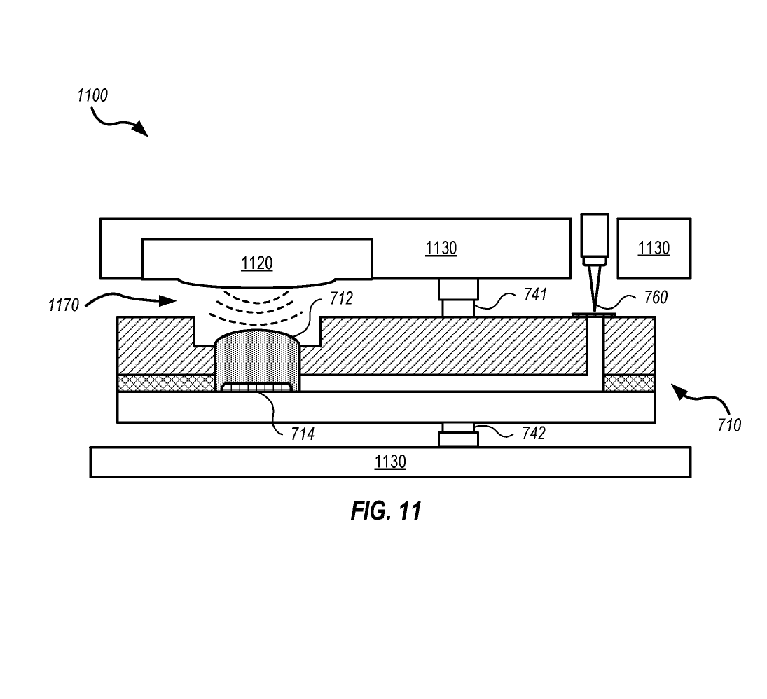

FIG. 11 illustrates one exemplary assay cartridge processing system 1100 for applying vibration to assay cartridge 710 through an ambient medium 1170, e.g., air. Assay cartridge processing system 1100 is an embodiment of assay cartridge processing system 500 (FIG. 5) and may be implemented in assay cartridge processing systems 100 (FIG. 1), 300 (FIG. 3) and/or 400 (FIG. 4). Assay cartridge processing system 1100 includes a fixture 1130, configured to hold assay cartridge 710, and a mechanical oscillator 1120 mounted to fixture 1130. Mechanical oscillator 1120 applies vibration to assay cartridge 710, and/or assay components located therein, through ambient medium 1170.

In an embodiment, mechanical oscillator 1120 includes a vibrating, flexible membrane similar to that found in a speaker. Optionally, fixture 1130 includes contact elements 741 and 742 for restricting movement of assay cartridge 710 to pivoting about a pivot point or axis defined by optional contact elements 741 and 742. Although contact points 741 and 742 are illustrated in the configuration of FIG. 8, it should be appreciated that assay cartridge processing system 1100 may include the contact point configuration of FIG. 7 as well without departing from the scope hereof. Assay cartridge processing system 1100 may further include puncture device 760

In one exemplary use scenario, sample 712 and assay reagents 714 are located in a portion of assay cartridge 710 that is in communication with mechanical oscillator 1120 through ambient medium 1170. This allows for vibration to be transferred directly to sample 712 and assay reagents 714, as opposed to through assay cartridge 710. In another exemplary use scenario, mechanical oscillator 1120 transfers vibration to assay cartridge 710 through ambient medium 1170, thereby indirectly inducing vibration of the assay components to be mixed. In yet another exemplary use scenario, vibration is transferred from mechanical oscillator 1120 to the sample components to be mixed directly through ambient medium 1170 and indirectly through ambient medium 1170 and assay cartridge 710.

Optionally, assay cartridge processing system 1100 includes puncture device 760.

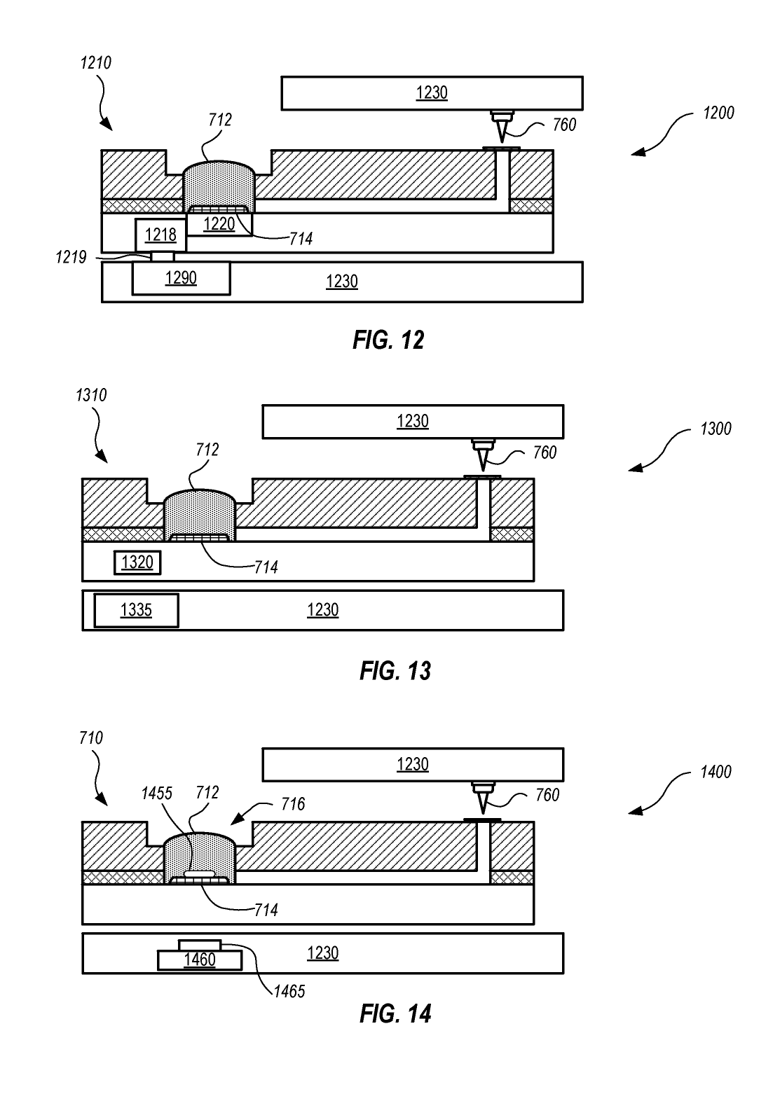

FIG. 12 illustrates one exemplary assay cartridge 1210 having an integrated mechanical oscillator 1220 in direct contact with a fluidic chamber of assay cartridge 1210, and one exemplary assay cartridge processing system 1200 for applying vibration to assay components in assay cartridge 1210 using mechanical oscillator 1220. Assay cartridge processing system 1200 may be implemented in assay cartridge processing system 100 (FIG. 1), 300 (FIG. 3), and/or 400 (FIG. 4) for processing of assay cartridge 1210. Assay cartridge 1210 is an embodiment of assay cartridge 710.

Assay cartridge processing system 1200 includes a fixture 1230, drive circuitry 1290, and, optionally, a spring-loaded element 1219. Assay cartridge 1210 includes electrical contacts 1218 that connect mechanical oscillator 1220 to external drive circuitry 1290, optionally through spring-loaded element 1219. In one embodiment, mechanical oscillator 1220 causes assay cartridge 1210 itself to vibrate and spring-loaded element 1219 may maintain electrical connection between electrical contacts 1218 and drive circuitry 1290 throughout the vibration. In another embodiment, fixture 1230 restricts movement of assay cartridge 1210 to rotation about a pivot point, in which case the electrical contact may be made at the pivot point without need for a spring-loaded element. In yet another embodiment, fixture 1230 restricts the assay cartridge motion to one or two dimensions electrical contact between drive circuitry 1290 and electrical contacts 1218 is made in a dimension not associated with motion.

Mechanical oscillator 1220 is in direct contact with fluids inside assay cartridge 1210 and transfers vibration directly to such fluids. For example, assay cartridge 1210 may contain sample 712 and assay reagents 714 that are to be mixed with, and optionally rehydrated by, sample 712.

Mechanical oscillator 1220, electrical contacts 1218, drive circuitry 1290, and optionally spring-loaded element 1219, together form an embodiment of agitation source 140 (FIG. 1). Optionally, assay cartridge processing system 1200 includes puncture device 760. Spring-loaded element 1219 may be incorporated in assay cartridge 1210 instead of in assay cartridge processing system 1200 without departing from the scope hereof.

FIG. 13 illustrates one exemplary assay cartridge 1310 having an integrated ferromagnetic material 1320, and one exemplary assay cartridge processing system 1300 for applying vibration to assay cartridge 1310 by magnetically inducing motion of ferromagnetic material 1320. Assay cartridge processing system 1300 may be implemented in assay cartridge processing system 100 (FIG. 1), 300 (FIG. 3), and/or 400 (FIG. 4) for processing of assay cartridge 1310. Assay cartridge 1310 is an embodiment of assay cartridge 710. Assay cartridge 1310 is similar to assay cartridge 1210 (FIG. 12) except for mechanical oscillator 1220 and electrical contacts 1218 being replaced by ferromagnetic material 1320. Assay cartridge processing system 1300 is similar to assay cartridge processing system 1200 (FIG. 12) except for (a) not including spring-loaded element 1219 and (b) drive circuitry 1290 being replaced by an induction coil 1335 that generates an oscillating magnetic field. Ferromagnetic material 1320 and induction coil 1335 together form an embodiment of agitation source 140. Induction coil 1335 may be replaced by another form of magnetic field generator without departing from the scope hereof.

Induction coil 1335 induces vibration of assay cartridge 1310 through magnetic interaction with ferromagnetic material 1320. Induction coil 1335 need not be in physical or electrical contact with assay cartridge 1310. Hence, agitation of assay cartridge 1310 by assay cartridge processing system 1300 does not require electrical contacts between assay cartridge 1310 and any devices external thereto.

FIG. 14 illustrates one exemplary assay cartridge processing system 1400 for applying agitation to assay components in an assay cartridge by inducing movement of a ferromagnetic stir element in direct contact with at least some of the assay components. Assay cartridge processing system 1400 is similar to assay cartridge processing system 1300 (FIG. 13) except for induction coil 1335 being replaced by a motor 1460 connected to a magnet 1465. Motor 1460 and magnet 1465 together form an embodiment of agitation source 140 (FIG. 1). Motor 1460 may be an electrical motor.

A stir element 1455, including a ferromagnetic material, is located in assay cartridge 710 in direct contact with at least some of the assay components that are to be mixed. When motor 1460 is activated, for example by controller 120 (FIG. 1), magnet 1465 moves. Movement of magnet 1465 magnetically couples with the ferromagnetic material of stir element 1455 to induce movement thereof. Stir element 1455 thereby agitates the assay components, which may result in mixing of the assay components. The movement of stir element 1455 may be synchronous with the movement of magnet 1465. Motor 1460 and magnet 1465 may be configured to produce substantially rotational or spinning movement of magnet 1465, which induces substantially rotational or spinning movement of stir element 1455. Stir element 1455 may have any shape capable of agitating at least some of the assay components. Possible shapes of stir element 1455 include, but are not limited to, a rod, a long rod, a cylinder, and a flat cylinder.

In an exemplary use scenario, shown in FIG. 14, assay cartridge processing system 1400 and stir element 1455 are used to mix, and optionally rehydrate, assay reagents 714 with sample 712 in an inlet port of assay cartridge 710. However, assay cartridge processing system 1400 and stir element 1455 may be used to mix other or more assay components and/or mix assay components in a different location of assay cartridge 710, without departing from the scope hereof.

In an example, stir element 1455 is a stir bar made of 304 stainless steel wire, with length of 3 mm and diameter of 0.25 mm. The stir bar is embedded in dried assay reagents, i.e., a dried assay reagent embodiment of assay reagents 714, located in inlet port 716, wherein the inlet port has diameter 4 mm. In this example, motor 1460 is an electrical stepper motor and magnet 1465 is a permanent magnet (length 6.4 mm, diameter 1.6 mm) affixed to a shaft of the electrical stepper motor. The stir bar is magnetically coupled to the permanent magnet. When the electrical stepper motor is activated, the stir bar rotates in the inlet port with a rotation frequency between 1 and 15 Hertz, causing the sample, e.g., sample 712, to mix with the dried assay reagents. The axis of rotation, the exact shape of the stir bar, the frequency of rotation, and the duration of mixing are parameters that affect the degree of mixing. These parameters may be optimized by the method of design of experiments (DOE).

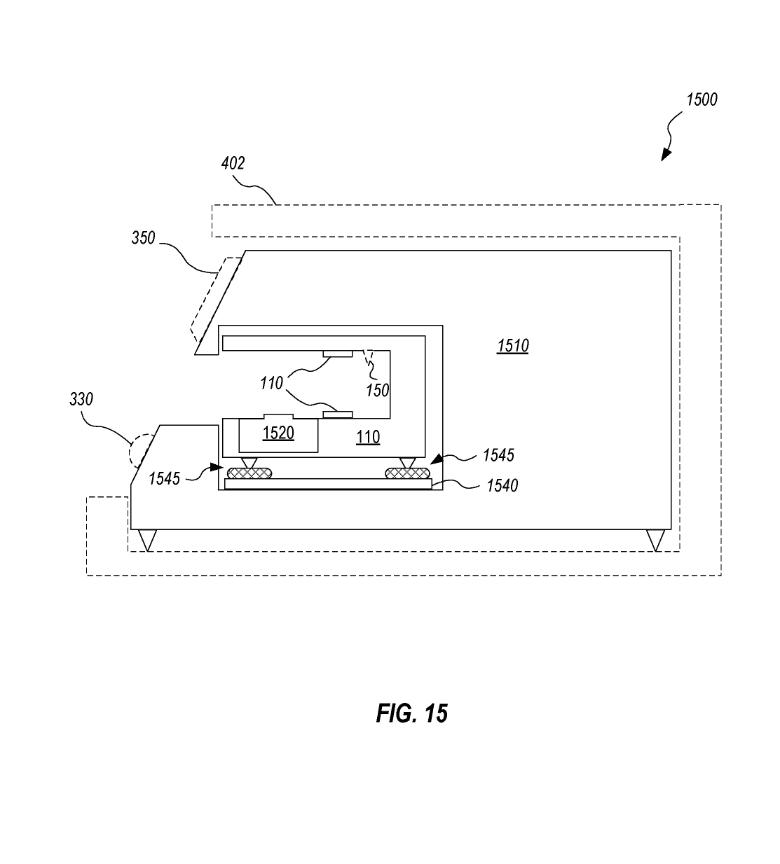

FIG. 15 illustrates, in cross-sectional side view, one exemplary assay cartridge processing system 1500 including a plurality of assay cartridge processing units 1510 and vibration decoupling features for preventing or reducing vibration transfer between individual assay cartridge processing units 1510 and/or from assay cartridge processing units 1510 to other structures external to assay cartridge processing system 1500. Assay cartridge processing unit 1510 is an embodiment of assay cartridge processing systems 100 (FIG. 1) and 300 (FIG. 3). Assay cartridge processing system 1500 is an embodiment of assay cartridge processing system 400 (FIGS. 4A and 4B).

Each assay cartridge processing unit 1510 includes an agitation source 1520, an embodiment of agitation source 140 (FIG. 1), for applying vibration to an assay cartridge or assay components therein. Agitation source 1520 is, for example, one or more of the embodiments of agitation source 140 discussed in connection with FIGS. 5, 6A-C, 7, 8, 9, 10, 11, 12, 13, and 14. Each assay cartridge processing unit 1510 further includes fixture 110 (FIG. 1) and, optionally, one or more of puncture device 150 (FIG. 1), display 350 (FIG. 3), and indicator 330 (FIG. 3). Additionally, each assay cartridge processing unit 1510 may include controller 320 (FIG. 3) and/or interface 370 (FIG. 3). As discussed in connection with FIGS. 4A and 4B, individual assay cartridge processing units 1510 may share at least portions of a common controller 320 and/or interface 370.

Assay cartridge processing system 1500 includes a support structure 1540 that holds each fixture 110. Support structure 1540 may be a connected mechanical structure or a collection of disconnected mechanical structures, for instance connecting the plurality of fixtures 110 in series. Support structure 1540 includes decoupling features 1545 that prevent, or reduce, transfer of vibration between individual assay cartridge processing units 1510. Decoupling features 1545 may also prevent or reduce transfer of vibration from assay cartridge processing units to mechanical structures external to assay cartridge processing system 1500. Examples of decoupling features 1545 include, but are not limited to, vibration damping materials such as rubber or silicone, optionally incorporated in support structure 1540 or fixtures 110. Decoupling features 1545 and/or support structure 1540 may be positioned differently from what is shown in FIG. 15 without departing from the scope hereof. For example, each fixture 110 may be hanging from decoupling features 1545 and support structure 1540. Furthermore, assay cartridge processing unit 1510 may include a different number of decoupling features 1545 than shown in FIG. 15, and/or assay cartridge processing system 1500 may include a different number of support structures 1540 than shown in FIG. 15, without departing from the scope hereof.

Assay cartridge processing system 1500 may include enclosure 402 or other mechanical structure for holding assay cartridge processing units 1510.

In an embodiment, assay cartridge processing system 1500 includes only a single assay cartridge processing unit 1510, and decoupling features 1545 serve to prevent or reduce transfer of vibration from assay cartridge processing unit 1510 to mechanical structures external to assay cartridge processing system 1500.

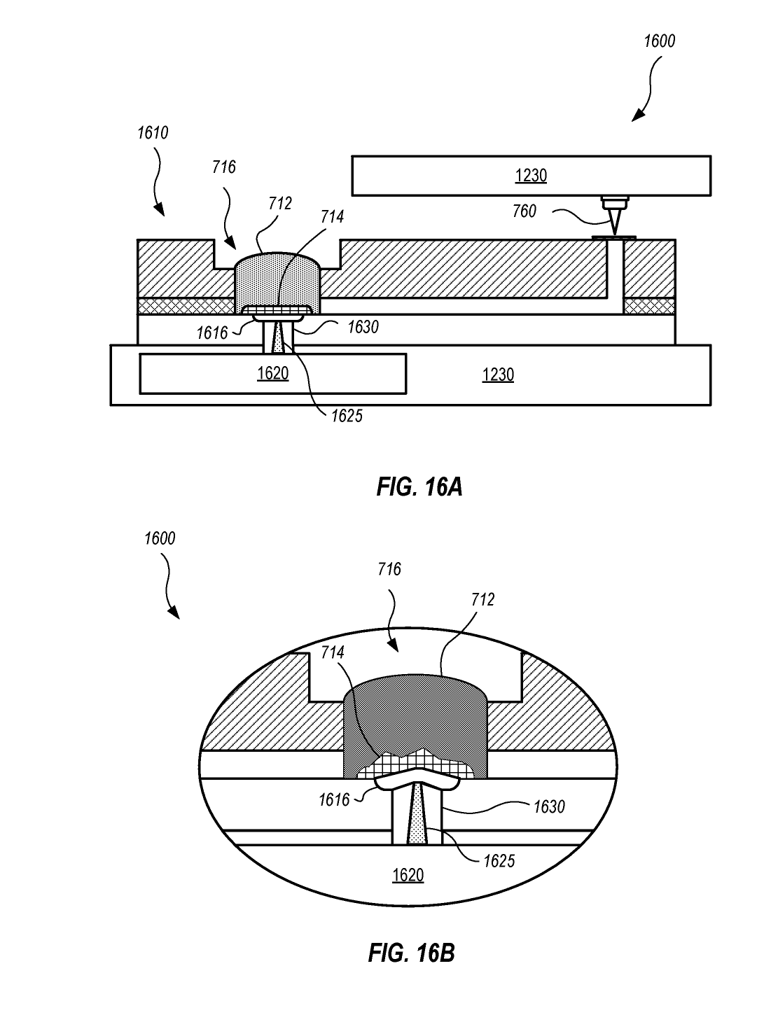

FIGS. 16A and 16B illustrate one exemplary assay cartridge 1610, having a flexible portion 1616 that interfaces with a desired local region of a fluidic chamber of assay cartridge 1610, together with one exemplary assay cartridge processing system 1600 for applying vibration to flexible portion 1616 to agitate assay components in assay cartridge 1610.

Assay cartridge 1610 is an embodiment of assay cartridge 180 (FIG. 1) similar to assay cartridge 710 except that assay cartridge 1610 includes flexible portion 1616 and a recess 1630 that provides access to flexible portion 1616 from outside assay cartridge 1610. Flexible portion 1616 interfaces with at least a portion of a fluidic chamber of assay cartridge 1610, such as inlet port 716 as shown in FIGS. 16A and 16B.

Assay cartridge processing system 1600 includes fixture 1230 (FIG. 12), a mechanical oscillator device 1620 with a contact element 1625. Optionally, assay cartridge processing system 1600 further includes puncture device 760. Assay cartridge processing system 1600 may be implemented in assay cartridge processing systems 100 (FIG. 1), 300 (FIG. 3), and/or 400 (FIG. 4) for processing of assay cartridge 1610. Mechanical oscillator device 1620 is an embodiment of agitation source 140 (FIG. 1). Contact element 1625 of mechanical oscillator device 1620 may contact flexible portion 1616 through recess 1630.

FIG. 16A shows assay cartridge processing system 1600 and assay cartridge 1610 with flexible portion 1616 in a nominal configuration associated with no force exerted thereon by assay cartridge processing system 1600. FIG. 16B shows a portion of assay cartridge processing system 1600 and assay cartridge 1610 when assay cartridge processing system 1600 exerts force on flexible portion 1616. When mechanical oscillator device 1620 is activated, for example by controller 320 (FIG. 3), contact element 1625 vibrates and thereby induces vibrational motion flexion of flexible portion 1616. Flexion of flexible portion 1616 agitates assay components interfacing with and/or located near flexible portion 1616.

In an embodiment, flexible portion 1616 is located underneath inlet port 716. In an exemplary use scenario, inlet port 716 contains sample 712 and assay reagents 714. Flexion of flexible portion 1616, induced by mechanical oscillator device 1620, may provide mixing, and optionally rehydration, of assay reagents 714 with sample 712. Assay cartridge processing system 1600 and assay cartridge 1610 may have particular advantages in scenarios where assay reagents 714 are in dried form. For example, the agitation of assay reagents 714 may help break up the dried substance, thereby increasing the surface area of the interface between dried and liquid components, such as sample 712, and as a result increasing the rehydration rate.

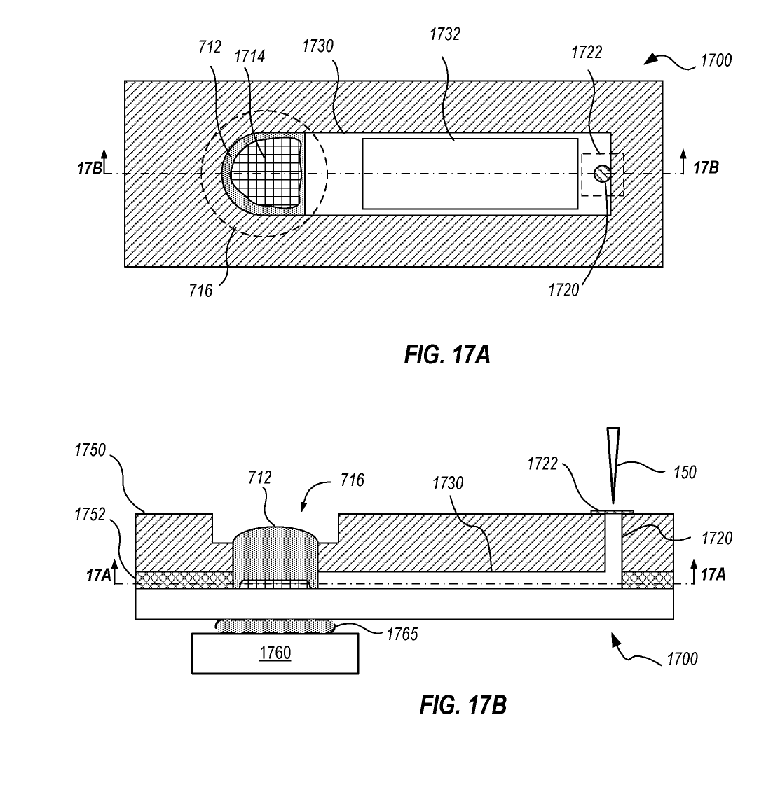

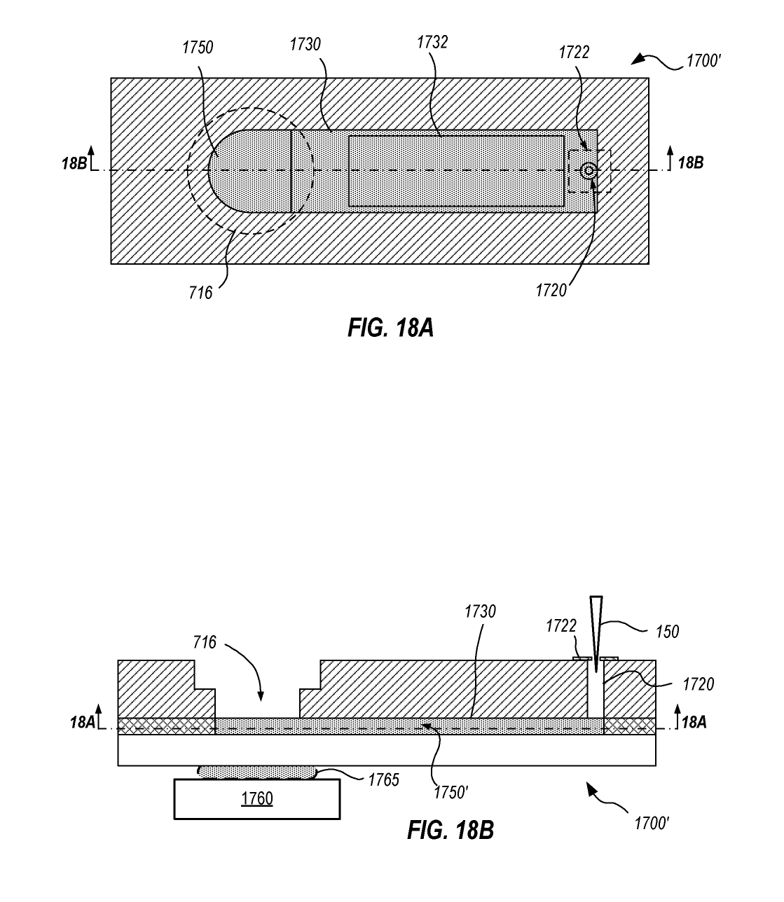

FIGS. 17A, 17B, 18A and 18B schematically illustrate one exemplary assay cartridge processing method for mixing assay components in an assay cartridge under controlled fluid flow conditions. This method may be performed by embodiments of assay cartridge processing system 100 (FIG. 1) that include agitation source 140 (FIG. 1) and puncture device 150 (FIG. 1).

FIGS. 17A and 17B show, in cross-sectional top view and cross-sectional side view, respectively, one exemplary assay cartridge 1700. FIG. 17A shows a cross section taken along line 17A-17A of FIG. 17B. FIG. 17B shows a cross section taken along line 17B-17B of FIG. 17A. Assay cartridge 1700 includes inlet port 716 in fluidic communication with a vent 1720 through a capillary channel 1730. Vent 1720 is an embodiment of outlet port/vent 186 (FIG. 1). Assay cartridge 1700 is an embodiment of assay cartridges 180 (FIG. 1), 710, 1210 (FIG. 12), 1310 (FIG. 13), and 1610 (FIG. 16). Inlet port 716 contains preloaded assay reagents 1714, for instance dried assay reagents. Assay reagents 1714 are an embodiment of assay reagents 714. A region for interrogating the assay to obtain assay results is indicated as detection region 1732. A frangible seal 1722 covers vent 1720. Frangible seal 1722 may be for example an adhesive vent cover. Liquid sample 712 is loaded into inlet port 716. Frangible seal 1722 is intact such that flow of liquid sample 712 into capillary channel 1730 is prevented. While liquid sample 712 is held in inlet port 716, vibration is applied for a desired amount of time by an agitation source 1760, which is, for example, one or more of the embodiments of agitation source 140 (FIG. 1) discussed in the present disclosure. In an embodiment, agitation source 1760 is a mechanical oscillator device that applies vibration to assay cartridge 1700 through direct contact therewith. In this embodiment, agitation source 1760 may include a flexible material 1765 located between agitation source 1760 and assay cartridge 1700. After a time determined by a user or by a controller, such as controller 120 (FIG. 1), frangible seal 1722 is punctured by puncture device 150 (FIG. 1).

FIGS. 18A and 18B show, in cross-sectional top view and cross-sectional side view, respectively, assay cartridge 1700′. Assay cartridge 1700′ is assay cartridge 1700 (FIGS. 17A and 17B) some time after that puncture device 150 has punctured frangible seal 1722. FIG. 18A shows a cross section taken along line 18A-18A of FIG. 18B. FIG. 18B shows a cross section taken along line 18B-18B of FIG. 18A. When puncture device 150 punctures frangible seal 1722, capillary forces draw sample 712 into capillary channel 1730. Displaced air escapes through vent 1720. Optionally, capillary channel 1730 and vent 1720 are configured such that flow is terminated when the fluidic front reaches vent 1720. This can be achieved by proper dimensioning and or material choices of capillary channel 1730 and vent 1720.

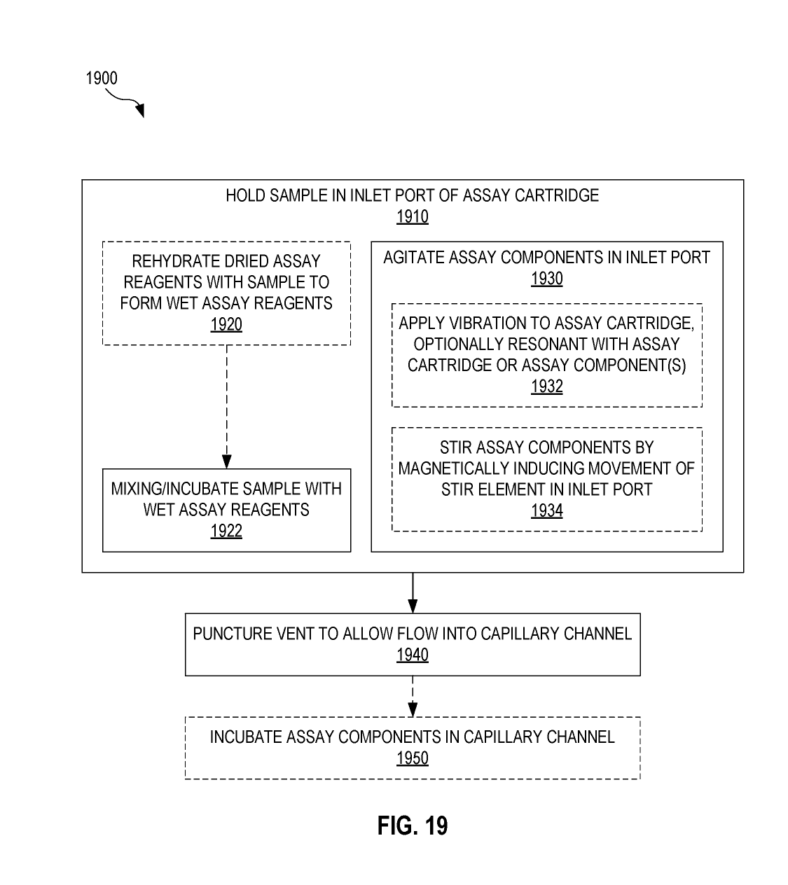

FIG. 19 is a flow chart illustrating one exemplary assay cartridge processing method 1900 for mixing assay components in an assay cartridge under controlled fluid flow conditions. Embodiments of assay cartridge processing system 100 (FIG. 1), which include agitation source 140 (FIG. 1) and puncture device 150 (FIG. 1), may perform assay cartridge processing method 1900 on embodiments of assay cartridge 180 that include a frangible seal, such as assay cartridge 1700 (FIGS. 17A and 17B). Assay cartridge processing method 1900 is similar to the assay cartridge processing method illustrated by FIGS. 17A, 17B, 18A, and 18B. Assay cartridge processing method 1900 is an embodiment of assay cartridge processing method 200 (FIG. 2).

In a step 1910, a sample is held in an inlet port of an assay cartridge. For example, assay cartridge processing system 100 (FIG. 1), with agitation source 140 and puncture device 150, processes assay cartridge 1700 (FIGS. 17A and 17B). By leaving frangible seal 1722 of assay cartridge 1700 (FIGS. 17A and 17B) intact, sample 712 is held in inlet port 716. Step 1910 includes a step 1930 of agitating assay components in the inlet port of the assay cartridge. For example, controller 120 (FIG. 1) activates agitation source 140 (FIG. 1) to agitate sample 712 and/or assay reagents 714 in inlet port 716 of assay cartridge 1700 (FIGS. 17A and 17B).

In one embodiment, step 1930 includes a step 1932, wherein vibration is applied to the assay cartridge, optionally at a frequency that is resonant with the assay cartridge or assay components to be mixed. For example, controller 120 activates one or more of embodiments of agitation source 140 (FIG. 1) illustrated in FIGS. 5, 6A-C, 7, 8, 9, 10, 11, 12, 13, 17A, and 17B to apply vibration to assay cartridge 1700.

In another embodiment, step 1930 includes a step 1934, wherein assay components are stirred by magnetically inducing movement of a stir element located in the inlet port of the assay cartridge. For example, controller 120 activates motor 1460 (FIG. 14) to induce movement of stir element 1455 (FIG. 14) located in inlet port 716 of assay cartridge 1700.

Step 1910 further includes a step 1922 of mixing and/or incubating the sample with wet assay reagents. Optionally, step 1922 is preceded and/or performed in parallel with a step 1920 wherein dried assay reagents are rehydrated by the sample to form wet assay reagents. In an example of steps 1920 and 1922, assay reagents 714 are dried assay reagents that are rehydrated and mixed, and optionally incubated, with sample 712 in inlet port 716 of assay cartridge 1700. Step 1922, and optionally step 1920, may take place before, during, and/or after step 1930.

In a step 1940, a vent of a capillary channel, fluidically connected with the inlet port of the assay cartridge, is punctured to allow fluid flow from the inlet port into the capillary channel. For example, puncture device 150 (FIGS. 1 and 3) punctures frangible seal 1722 (FIGS. 17A and 17B) to initiate flow into capillary channel 1730. Step 1940 may be performed by systems that include puncture device 150 or 760 (FIG. 7), such as embodiments of assay cartridge processing systems shown in FIGS. 1, 3, 7-16B, which include an optional puncture device capable of puncturing a frangible seal. For example, assay cartridge processing system 700 of FIG. 7 and assay cartridge processing system 800 of FIG. 8 include optional puncture device 760 for puncturing a frangible seal 722 over a vent 718 of assay cartridge 710. In assay cartridge processing system 800, the pivot point/axis of assay cartridge processing system 800 is configured such that a particularly large vibration amplitude applied to assay cartridge 710 by mechanical oscillator 720 may result in puncture device 760 puncturing frangible seal 722.

In an embodiment, assay cartridge processing method 1900 further includes a step 1950, wherein assay components are incubated in the capillary channel. For example, sample 712 and assay reagents 714, optionally rehydrated, are allowed to incubate further in capillary channel 1730 of assay cartridge 1700. In another example, sample 712, and optionally assay reagents 714 are incubated with other assay components, such as a microarray of assay components, in capillary channel 1730.

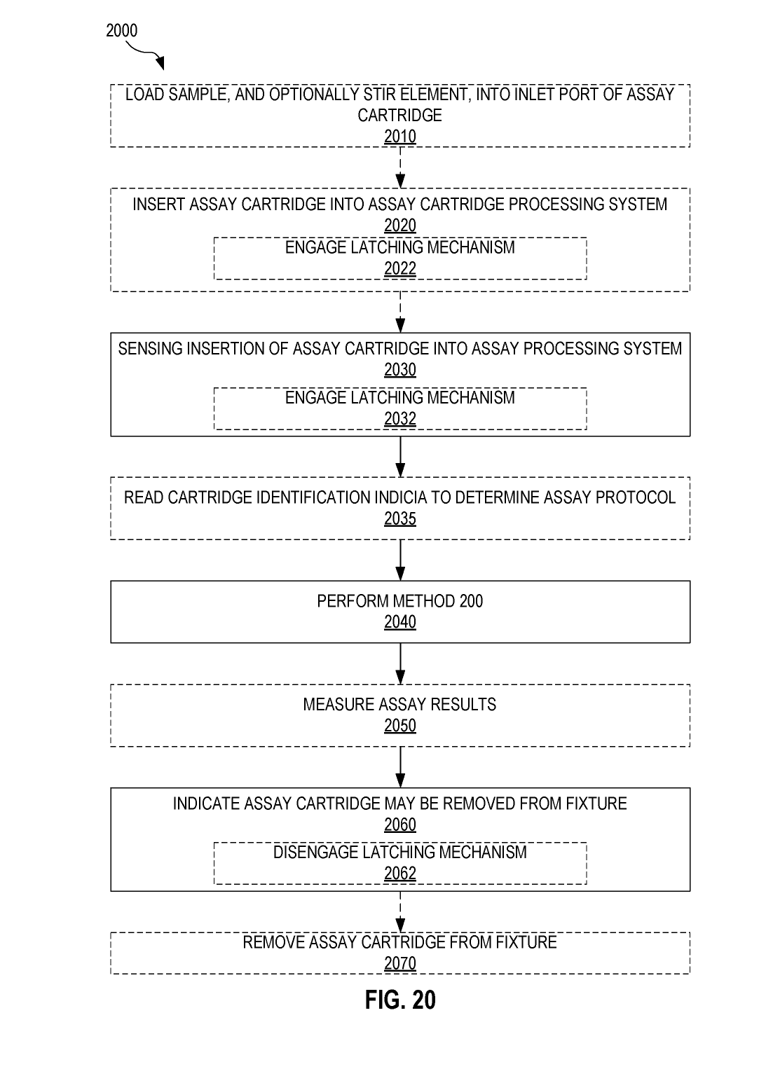

FIG. 20 illustrates one exemplary assay cartridge processing assay cartridge processing method 2000. At least portions of assay cartridge processing method 2000 are performed by an assay cartridge processing system, such as assay cartridge processing system 100 (FIG. 1) or assay cartridge processing system 300 (FIG. 3), or one of the embodiments thereof disclosed herein.

In an optional step 2010, a sample is loaded into an inlet port of an assay cartridge. For example, a user loads sample 712 into inlet port 716 of assay cartridge 710. In an embodiment, step 2010 includes loading a stir element into the inlet port. For example, a user loads stir element 1455 (FIG. 14) into inlet port 716 of assay cartridge 710.

In another optional step 2020, the assay cartridge is inserted into the assay cartridge processing system. For example, assay cartridge 180 (FIG. 1), or assay cartridge 710, is inserted into fixture 310 (FIG. 3) of assay cartridge processing system 300 (FIG. 3). Step 2020 may be performed by a user, by an automatic cartridge insertion device (e.g., an automatic loading tray similar to those used in a compact disk drive), or by a combination thereof. Step 2020 may include a step 2022, wherein a latching mechanism is engaged to secure the assay cartridge in the fixture. For example, insertion of assay cartridge 180 or 710 into fixture 310 engages latching mechanism 314 (FIG. 3) which prevents removal of assay cartridge 180 or 710 from fixture 310.

In a step 2030, insertion of the assay cartridge into the fixture is sensed. For example, cartridge sensor 316 (FIG. 3) senses insertion of assay cartridge 180 or assay cartridge 710 into fixture 310. Cartridge sensor 316 communicates a signal to controller 320 (FIG. 3) that indicates that assay cartridge 180 (or 710) has been inserted into fixture 310. Controller 320 may initialize timer 342 (FIG. 3) upon sensing of cartridge insertion. In embodiments of assay cartridge processing method 2000 that do not include step 2022, step 2030 may include a step 2032 of engaging a latching mechanism. Step 2032 is similar to step 2022 except that step 2032 is initiated by sensing, by a sensor such as cartridge sensor 316, cartridge insertion into the assay cartridge processing system.

In an optional step 2035, cartridge identification indicia are read to determine the type of the assay cartridge and, thereby, which assay protocol should be performed on the assay cartridge. For example, code reader device 326 (FIG. 3) reads a barcode, or other identification indicia, on assay cartridge 180 or 710. Controller 320 may determine the type of cartridge from the barcode reading and retrieve from memory 362 which assay protocol is associated with the determined type of cartridge.

In a step 2040, assay cartridge processing method 2000 performs assay cartridge processing method 200 (FIG. 2) or an embodiment thereof such as assay cartridge processing method 1900 (FIG. 19), as discussed in connection with FIGS. 2 and 19, respectively. In an example of step 2040, controller 320 (FIG. 3) of assay cartridge processing system 300 retrieves an assay protocol from memory 362 and performs steps of assay cartridge processing method 200, or assay cartridge processing method 1900, in accordance therewith. Controller 320 may use timing module 340 (FIG. 3) to control timing of steps of assay cartridge processing method 200, or 1900, according to the assay protocol. Timing module 340 may reference timing of such assay processing steps to the time at which cartridge insertion was sensed in step 2030. Timing module 340 may utilize timer 342 for this purpose.

In an optional step 2050, assay results are measured. For example, measurement device 195 (FIGS. 1 and 3) measures results of an assay in assay cartridge 180 or 710.

In a step 2060, the assay cartridge processing system indicates that the assay cartridge may be removed from the fixture. For example, controller 320 controls indicator 330 or display 350 to indicate to a user that the assay cartridge may be removed from fixture 310. In embodiments of assay cartridge processing method 2000 that include step 2022, step 2060 includes a step of disengaging the latching mechanism.

In an optional step 2070, the assay cartridge is removed from the fixture. For example, the assay cartridge is removed from fixture 110 of assay cartridge processing system 300. Step 2070 may be performed by a user, by an automatic cartridge insertion device such as an automatic loading tray similar to those used in a compact disk drive, or by a combination thereof.

### Example I

Cartridges with integrated dried reagents for a fluorescence-based CD4+ T cell counting assay were prepared and assembled as described in connection with FIGS. 17A and 17B. Prior to performing an assay with the cartridge, each vent, e.g., vent 1720 of FIGS. 17A and 17B, was sealed with adhesive tape (Nunc Aluminum Seal Tape), forming a frangible seal, e.g., frangible seal 1722 (FIGS. 17A and 17B). By covering vent 1720, the fluidic channel, e.g., capillary channel 1730 (FIGS. 17A and 17B) became a closed end, effectively a hermetically sealed chamber. In this specific example, a 10 microliter whole blood sample was added to each inlet port, e.g., inlet port 716 (FIGS. 17A and 17B) using a transfer pipet. The blood samples sat in inlet ports without entering fluidic channels. A total of 20 cartridges were prepared, all of which were processed with a 30 second hold time of the sample in the inlet port. Five of the 20 cartridges were subjected to vibration during those 30 seconds. These five cartridges were held in a fixture. An enclosed, offset weight motor was mounted onto the fixture and interfaced therewith through a silicone gasket (as illustrated in FIG. 6A). For comparison, another set of five cartridges were processed without vibration; five cartridges were placed on a Thermo shaker operating at 1200 rpm during the 30 second hold time; and five cartridges were place on a Fisher Scientific shaker operating at 600 rpm during the 30 second hold time.

After the 30 second hold, each vent was opened by manually puncturing each respective frangible seal, as illustrated in FIGS. 18A and 18B. Immediately upon puncturing the frangible seal, blood flowed into each respective fluidic channel. The resulting blood-filled cartridges were then allowed to incubate on the bench top at ambient temperature (˜21° C.) for 20 minutes. Absolute CD4+ T cell counts were generated by optical interrogation of the detection region. For each set of five cartridges, the coefficient of variation (CV) of the absolute CD4+ T cell counts was calculated.

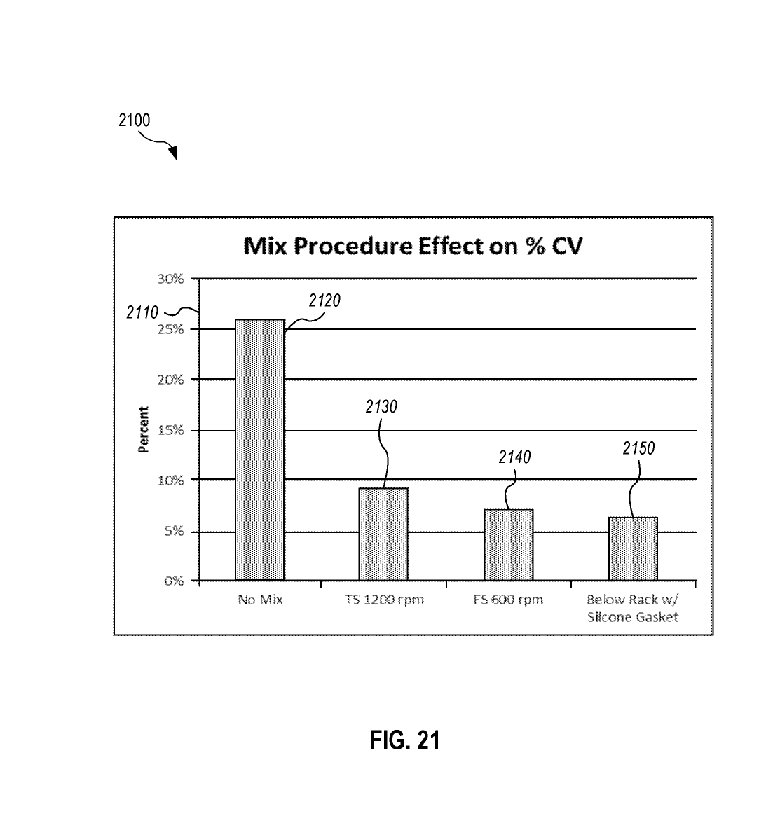

FIG. 21 shows the resulting CVs (2110) for different methods of applying vibration, including no vibration. It is clear that the reproducibility is greatly improved when applying vibration during the hold time (data labeled 2130, 2140, and 2150). Without vibration, the CV is 26% (data labeled 2120). Using the conventional shaker devices, CVs of 9% and 7%, respectively, are achieved for Thermo at 1200 rpm (data labeled 2130) and Fisher Scientific at 600 rpm (data labeled 2140). The offset weight motor applied to the fixture through a silicone gasket (data labeled 2150) yields a slightly lower CV than the Fisher Scientific shaker. This example demonstrates that improved rehydration and mixing properties are obtained when vibration is applied in conjunction with a sample hold protocol. Further, high performance is achieved using a low-cost offset weight motor.

### Example II

In a similar example, 15 cartridges were processed using the same protocol as discussed in Example I. In the present example, a compact, enclosed, offset weight motor of the type used in cell phones was touched directly to the cartridge (as illustrated in FIGS. 17A and 17B with agitation source 1760 without optional flexible material 1765). For a set of five cartridges, the offset weight motor was touched to the cartridge directly underneath the inlet port. For another set of five cartridges, the offset weight motor was touched to the cartridge underneath the fluidic channel at a position about 20 mm downstream from the inlet port. The last set of five cartridges were not subjected to vibration.

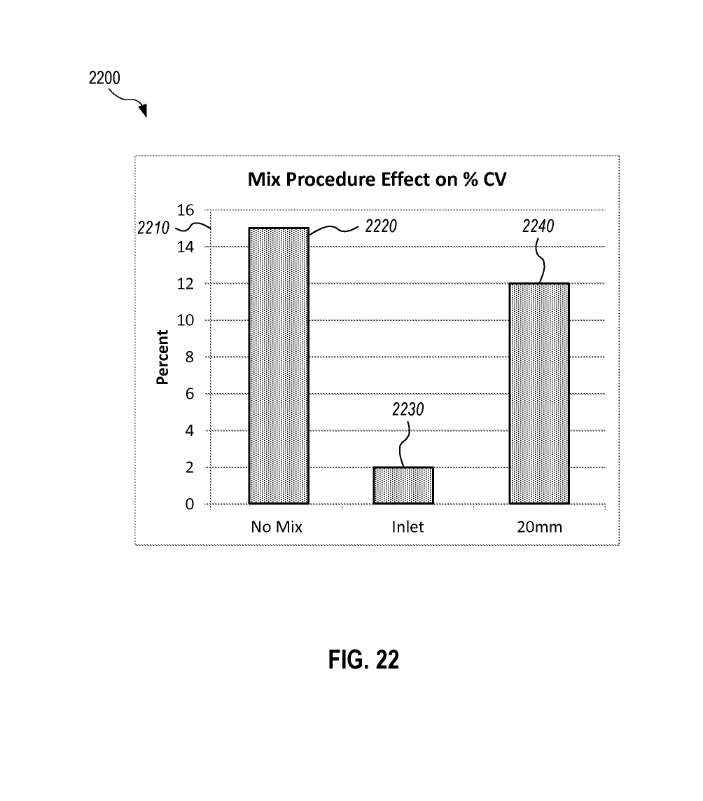

FIG. 22 shows the resulting CVs (2210) for the different positions of vibration application (inlet port: data labeled 2230, 20 mm downstream: data labeled 2240) and for no vibration application (data labeled 2240). A striking improvement is observed when vibration is applied directly underneath the inlet port (data labeled 2230). Although application of vibration further away from the inlet port (data labeled 2240) also shows some improvement over the no-vibration protocol (data labeled 2220), applying the vibration locally at the inlet port is superior. This demonstration emphasizes that a small motor, with low power consumption and designed for battery operation, is capable of producing good mixing when applied in a proper location.

Combinations of Features

Features described above as well as those claimed below may be combined in various ways without departing from the scope hereof. For example, it will be appreciated that aspects of one assay cartridge processing system, method, or associated assay cartridge described herein may incorporate or swap features of another assay cartridge processing system, method, or associated assay cartridge described herein. The following examples illustrate some possible, non-limiting combinations of embodiments described above. It should be clear that many other changes and modifications may be made to the methods and device herein without departing from the spirit and scope of this invention:

(A1) A cartridge processing system for controlling and performing operations on at least one assay cartridge includes, for each of the at least one assay cartridge (a) a fixture for holding the assay cartridge and (b) electronic circuitry for control and/or performance of operations performed on the assay cartridge, such that at least portions of the operations, needed to complete an assay onboard the assay cartridge, is performed by the cartridge processing system.

(A2) In the cartridge processing system denoted as (A1), the electronic circuitry may include one or more of a timing system and an indicator system.

(A3) In the cartridge processing system denoted as (A2), the timing system may include one of more timers for timing of operations performed by the cartridge processing system on the assay cartridge, processes taking place within the assay cartridge while in the cartridge processing system, or a combination thereof.

(A4) In the cartridge processing systems denoted as (A2) and (A3), the indicator system may include one or more of audible and visible cues for communicating to an operator status of processes performed by the cartridge processing system on the assay cartridge, processes taking place within the assay cartridge while in the cartridge processing system, or a combination thereof.

(A5) In the cartridge processing system denoted as (A4), the indicator system may include one or more indicator lights indicating the status by its state, wherein possible states may include on, off, and on with a specific one of a set of possible colors.

(A6) In the cartridge processing systems denoted as (A2) through (A5), the indicator system may include a display indicating timing information provided by one or more timers of the timing system.

(A7) In the cartridge processing systems denoted as (A1) through (A6), the fixture may include a cartridge detection mechanism for detecting the presence of a cartridge within the fixture, wherein the cartridge detection mechanism, upon insertion of a cartridge into the fixture, initializes at least one of one or more timers of the timing system.

(A8) The cartridge processing systems denoted as (A1) through (A7) may further include a vibration mechanism for mixing of assay components within the cartridge.

(A9) In the cartridge processing system denoted as (A8), the assay components may include at least a sample and one or more assay reagents.

(A10) In the cartridge processing system denoted as (A9), at least one of the one or more assay reagents may be a dried reagent located onboard the assay cartridge prior to loading of the sample into the assay cartridge.

(A11) In the cartridge processing systems denoted as (A1) through (A10), the assay cartridge may include (a) an inlet port and a vent in fluidic communication with each other through a capillary fluidic channel and (b) dried assay reagents located in the inlet port.

(A12) In the cartridge processing system denoted as (A11), the vent may include a frangible seal, and the cartridge processing system may include a breaking mechanism for breaking the frangible seal, such that a sample is held in the inlet port for a desired hold time while the vent is sealed and flow into the channel is initiated upon breaking, by the breaking mechanism, of the frangible seal.

(A13) In the cartridge processing system denoted as (A12), the hold time may be controlled by one or more timers and initiated upon detection, by a cartridge detection mechanism, of cartridge insertion.

(A14) In the cartridge processing systems denoted as (A11) and (A12), the sample may rehydrate at least a portion of the dried assay reagents during the hold time.

(A15) The cartridge processing systems denoted as (A1) through (A14) may further include a vibration mechanism for mixing a sample with dried assay reagents before, during, and/or after rehydration thereof.

(A16) In the cartridge processing systems denoted as (A8) and (A15), the vibration mechanism may be a mechanical oscillator in physical contact with the assay cartridge or the fixture holding the assay cartridge, and the mechanical oscillator may be controlled by the electronic circuitry.

(A17) In the cartridge processing system denoted as (A16), the mechanical oscillator may be one or more of an offset weight motor, an induction coil vibrator, a piezoelectric material, and a combination thereof.

(A18) In the cartridge processing systems denoted as (A15) through (A17), the vibration mechanism may be tuned to a vibration frequency resonant with movement of at least a portion of the sample.

(B1) A method for processing an assay cartridge with assay reagents may include (a) loading a sample into the assay cartridge such that the sample is in contact with the assay reagents and (b) applying a vibration to at least one of the sample, the assay reagents, and the assay cartridge.

(B2) The method denoted as (B1) may further include initiating fluidic flow after applying a vibration.

(B3) In the method denoted as (B2), the assay cartridge may include an inlet port in fluidic communication with a vent through a fluidic channel, the vent having a frangible seal, and the step of initiating fluidic flow may include breaking the frangible seal.

(B4) The methods denoted as (B1) through (B3) may further include incubating the sample and the assay reagents.

(B5) The methods denoted as (B1) through (B4) may further include reading information indicators on the assay cartridge and using the information to define timing and duration of processes.

(C1) A method for processing an assay cartridge including an inlet port, with dried assay reagents, in fluidic communication with a vent, having a frangible seal, through a fluidic channel may include (a) loading a sample into the inlet port, (b) applying a vibration to at least one of the sample, the dried assay reagents, and the assay cartridge, (c) incubating the sample with at least one of the dried assay reagents and rehydrated dried assay reagents, and (d) initiating flow into the fluidic channel by breaking the frangible seal.

(C2) The method denoted as (C1) may further include incubating the sample with the rehydrated dried assay reagents after initiating flow into the fluidic channel.

(C3) The methods denoted as (C1) and (C2) may further include terminating flow after that the sample has filled a part of the fluidic channel.

(C4) The methods denoted as (C1) through (C3) may further include terminating flow after that the sample has propagated a certain length down the fluidic channel.

(D1) An assay cartridge processing system may include (a) a fixture for holding an assay cartridge, (b) at least one agitation source for agitating, when the assay cartridge is held in the fixture, assay components within a fluidic chamber of the assay cartridge, and (c) a timing module including electronic circuitry, communicatively coupled with the agitation source, for controlling timing of operation of the agitation source.

(D2) In the assay cartridge processing system denoted as (D1), the at least one agitation source may include at least one mechanical oscillator for applying vibration to the assay cartridge, wherein the mechanical oscillator is at least periodically coupled with the assay cartridge when the assay cartridge is fully inserted in the fixture.

(D3) In the assay cartridge processing system denoted as (D2), the mechanical oscillator may be at least periodically coupled with the assay cartridge via direct contact.

(D4) In the assay cartridge processing system denoted as (D3), the mechanical oscillator may be at least periodically coupled with the assay cartridge via indirect contact.

(D5) In the assay cartridge processing systems denoted as (D2) through (D4), the mechanical oscillator may include at least one of a piezoelectric material, an offset-weight motor, and an induction coil vibrator.

(D6) In the assay cartridge processing systems denoted as (D1) through (D5), the at least one agitation source may include an oscillating-magnetic-field generator for generating an oscillating magnetic field to magnetically induce motion of the assay cartridge by inducing motion of a magnetic material rigidly coupled therewith.

(D7) In the assay cartridge processing systems denoted as (D1) through (D6), the at least one agitation source may include a magnetic field generator for generating a temporally varying magnetic field to induce motion of a magnetic stir element within the fluidic chamber.

(D8) In the assay cartridge processing system denoted as (D7), the magnetic field generator may be an electrical motor coupled with a permanent magnet for generating a rotating magnetic field.

(D9) In the assay cartridge processing systems denoted as (D1) through (D8), the at least one agitation source may apply agitation at a frequency that is resonant with motion of at least one of (a) the assay cartridge and (b) one or more of the assay components.

(D10) The assay cartridge processing systems denoted as (D1) through (D9) may further include a puncture device for puncturing the fluidic chamber to allow fluid flow through the fluidic chamber.

(D11) The assay cartridge processing systems denoted as (D1) through (D10) may further include a sensor for sensing insertion of the assay cartridge into the fixture.

(D12) In the assay cartridge processing systems denoted as (D1) through (D11), the timing module may include electronic circuitry, communicatively coupled with the sensor and the puncture device, for controlling timing of puncturing by the puncture device relative to sensed insertion of the assay cartridge into the fixture by the sensor.

(D13) The assay cartridge processing systems denoted as (D1) through (D12) may further include a sensor for sensing insertion of the assay cartridge into the fixture, and the timing module may include electronic circuitry for controlling timing of agitation by the agitation source relative to sensed insertion of the assay cartridge into the fixture by the sensor.

(D14) The assay cartridge processing systems denoted as (D1) through (D13) may further include an indicator system for indicating status of processing of the assay cartridge.

(E1) An assay cartridge processing method may include (a) applying agitation to an assay cartridge, using an electronically controlled agitation source, to mix assay components in the assay cartridge, and (b) electronically controlling timing of the step of applying agitation.

(E2) The assay cartridge processing method denoted as (E1) may further include sensing, using a sensor, insertion of the assay cartridge into a fixture, and the step of electronically controlling timing of the step of applying agitation may include controlling timing of the step of applying agitation based upon time of insertion of the assay cartridge into the fixture.

(E3) In the assay cartridge processing methods denoted as (E1) and (E2), the step of applying agitation may include applying vibration to the assay cartridge using a mechanical oscillator that is at least periodically coupled with the assay cartridge.

(E4) In the assay cartridge processing methods denoted as (E1) and (E3), the step of applying agitation may include generating a temporally varying magnetic field and inducing motion of a magnetic stir element in the assay cartridge using the temporally varying magnetic field.

(E5) In the assay cartridge processing methods denoted as (E1) through (E4), the step of applying agitation may include applying agitation at a frequency that is resonant with motion of at least one of (a) the assay cartridge and (b) one or more of the assay components.

(E6) In the assay cartridge processing methods denoted as (E1) through (E5), the step of applying agitation may include applying agitation to mix assay components in an inlet port of the assay cartridge.

(E7) The assay cartridge processing method denoted as (E6) may further include, after initiating the step of agitation, puncturing a vent of a capillary channel of the assay cartridge to allow fluid flow from the inlet port into the capillary channel.

(E8) The assay cartridge processing method denoted as (E7) may further include controlling timing of the step of puncturing relative to at least one of (a) insertion of the assay cartridge into a fixture and (b) the step of applying agitation.

(E9) The assay cartridge processing methods denoted as (E1) through (E8) may further include sensing, using a sensor, insertion of the assay cartridge into the fixture.

(E10) The assay cartridge processing methods denoted as (E1) through (E9) may further include indicating status of assay performed in the assay cartridge.

(F1) An assay cartridge processing system may include (a) a fixture for holding an assay cartridge, (b) a puncture device for puncturing a fluidic chamber of the assay cartridge, when the assay cartridge is held in the fixture, to allow fluid flow through the fluidic chamber, and (c) a timing module including electronic circuitry, communicatively coupled with the puncture device, for controlling timing of puncturing by the puncture device.

(F2) The assay cartridge processing system denoted as (F1) may further include a sensor for sensing insertion of the assay cartridge into the fixture.

(F3) In the assay cartridge processing systems denoted as (F1) and (F2), the timing module may include electronic circuitry for controlling timing of puncturing by the puncture device relative to insertion of the assay cartridge into the fixture.

(G1) An assay cartridge processing method may include (a) puncturing a vent of a capillary channel of an assay cartridge to allow fluid flow from an inlet port of the assay cartridge into the capillary channel, and (b) electronically controlling timing of the step of puncturing.

(G2) The assay cartridge processing method denoted as (G1) may further include sensing, using a sensor, insertion of the assay cartridge into a fixture.

(G3) In the assay cartridge processing methods denoted as (G1) and (G2), the step of electronically controlling timing of the step of puncturing may include controlling timing of the step of puncturing based upon time of insertion of the assay cartridge into the fixture.

(G4) The assay cartridge processing methods denoted as (G1) through (G3) may further include, before the step of puncturing, holding a sample in the inlet port to mix the sample with assay reagents located in the inlet port.

(G5) In the assay cartridge processing method denoted as (G4), the step of holding the sample in the inlet port may include applying agitation to at least one of the assay cartridge and assay components to mix the sample with the assay reagents.

(G6) In the assay cartridge processing methods denoted as (G4) and (G5), the step of holding the sample in the inlet port may include (a) rehydrating dried assay reagents in the inlet port with the sample to form wet assay reagents, and (b) incubating the sample with the wet assay reagents.

(H1) An assay cartridge may include (a) a capillary channel, (b) an inlet port including dried assay reagents for reacting with a sample loaded into the assay cartridge via the inlet port, and (c) a vent in fluidic communication with the inlet port through the capillary channel, wherein the vent includes a frangible seal for preventing fluid flow from the inlet port towards the vent when the frangible seal is intact.

(H2) In the assay cartridge denoted as (H1), the frangible seal may be a cover on the vent.

(H3) In the assay cartridges denoted as (H1) and (H2), the cover may include an adhesive for interfacing with the vent to form a seal.

(H4) The assay cartridges denoted as (H1) through (H3) may further include a magnetic stir element for stirring assay components in the inlet port when a temporally varying magnetic field is applied to the magnetic stir element.

Changes may be made in the above methods and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which, as a matter of language, might be said to fall therebetween.

1. An assay cartridge processing system comprising:
a fixture for holding an assay cartridge; and
at least one agitation source, integrated with the fixture, for mixing assay components within a fluidic chamber of the assay cartridge.

2. The assay cartridge processing system of claim 1, the at least one agitation source including at least one mechanical oscillator for vibrating the assay cartridge through mechanical coupling between the mechanical oscillator and an external surface of the assay cartridge.

3. The assay cartridge processing system of claim 2, the mechanical oscillator being at least intermittently in direct contact with the external surface.

4. The assay cartridge processing system of claim 2, the mechanical oscillator being at least intermittently coupled with the external surface via the fixture.

5. The assay cartridge processing system of claim 2, the mechanical oscillator including at least one of a piezoelectric material, an offset-weight motor, and an induction coil vibrator.

6. The assay cartridge processing system of claim 1, the at least one agitation source including an oscillating-magnetic-field generator for generating an oscillating magnetic field to magnetically induce motion of the assay cartridge by inducing motion of a magnetic material rigidly coupled thereto.

7. The assay cartridge processing system of claim 1, the at least one agitation source including a magnetic field generator for generating a temporally varying magnetic field to induce motion of an oblong magnetic stir element within an inlet port of the fluidic chamber.

8. (canceled)

9. The assay cartridge processing system of claim 7, the magnetic field generator being configured to produce spinning movement of the oblong magnetic stir element.

10. The assay cartridge processing system of claim 1, further comprising a puncture device, integrated with the fixture, for puncturing a vent of the fluidic chamber to allow fluid flow through the fluidic chamber.

11. The assay cartridge processing system of claim 10, further comprising:
a sensor for sensing insertion of the assay cartridge into the fixture; and
electronic circuitry, communicatively coupled with the sensor and the puncture device, for controlling said puncturing at least partly based upon insertion of the assay cartridge into the fixture as sensed by the sensor.

12. (canceled)

13. The assay cartridge processing system of claim 1, further comprising:
a sensor for sensing full insertion of the assay cartridge into the fixture; and
electronic circuitry for controlling agitation by the agitation source at least partly based upon insertion of the assay cartridge into the fixture as sensed by the sensor.

14. (canceled)

15. An assay cartridge processing method comprising:
holding an assay cartridge in a fixture; and
agitating the assay cartridge, using an agitation source integrated with the fixture, to mix assay components in the assay cartridge.

16. The assay cartridge processing method of claim 15, further comprising:
sensing full insertion of the assay cartridge into the fixture; and
performing the step of agitating at least partly based upon said sensing full insertion.

17. The assay cartridge processing method of claim 15,
the step of holding comprising holding the assay cartridge in the fixture such that the assay cartridge is movable relative to the fixture; and
the step of agitating comprising vibrating an external surface of the assay cartridge through physical coupling of the external surface to a mechanical oscillator integrated with the fixture.

18. The assay cartridge processing method of claim 15, the step of agitating comprising:
generating a temporally varying magnetic field to induce motion of an oblong magnetic stir element in the assay cartridge.

19. The assay cartridge processing method of claim 18, the step of generating comprising generating the temporally varying magnetic field to induce motion of the oblong magnetic stir element within an inlet port of the assay cartridge.

20. The assay cartridge processing method of claim 15, further comprising puncturing a vent of a capillary channel of the assay cartridge, using a puncture device integrated with the fixture, to allow flow of the assay components, mixed in the step of agitating, from the inlet port into the capillary channel.

21. (canceled)

22. The assay cartridge processing method of claim 20, further comprising:
sensing insertion of the assay cartridge into the fixture; and
performing one or both of the step of puncturing and the step of agitating based at least in part upon said sensing insertion.

23-24. (canceled)

25. An assay cartridge processing system comprising:
a fixture for holding an assay cartridge; and
a puncture device, integrated with the fixture, for puncturing a fluidic chamber of the assay cartridge to allow fluid flow through the fluidic chamber, the puncture device being configured to puncture the fluidic chamber through physical contact between the puncture device and the fluidic chamber.

26. The assay cartridge processing system of claim 25, further comprising:
a sensor for sensing insertion of the assay cartridge into the fixture; and
electronic circuitry for controlling said puncturing at least partly based upon insertion of the assay cartridge into the fixture as sensed by the sensor.

27-39. (canceled)
